(19) United States
(12) Patent Application Publication
(10) Pub. No.: US 2003/0105824 A1
(43) Pub. Date: Jun. 5, 2003

(54) Systems and methods for disseminating information

(76) Inventors: Irvin W. Brechner, Metuchen, NJ (US); Donald W. Gould JR., Tampa, FL (US); Harry L. Greene, Brandon, FL (US); Eric S. Obeck, Tampa, FL (US); Paul Soltoff, St. Petersburg, FL (US)

Correspondence Address: FISH & NEAVE, 1251 AVENUE OF THE AMERICAS, 50TH FLOOR, NEW YORK, NY, 10020-1105, US

(21) Appl. No.: 10/039,702

(22) Filed: Jan. 2, 2002

Related U.S. Application Data
(63) Continuation of application No. 09/998,053, filed on Nov. 29, 2001.

(51) Int. Cl. G06F 15/16

(52) U.S. Cl. 709/206

(57) ABSTRACT

A centralized information dissemination system automatically distributes information received from information disseminators to information requestors. Information disseminators may register with a central facility to obtain an information address and to submit materials that are to be associated with the information address. Information disseminators may publish the information address to inform the public of the availability of the information distribution system. An information requestor may send a message addressed to a published information address at the central facility to automatically receive information. The central facility may respond to the message by sending a reply message that includes materials submitted by an information disseminator. An information disseminator may register different information addresses for advertisements for the same product or service that are presented to users through different media so that the information disseminator may track advertisements across different media. Other features and enhancements are also described.

### BACKGROUND OF THE INVENTION

The present invention relates to information dissemination systems and particularly to streamlined systems and methods for disseminating information.

With the advent of the Internet, consumers and businesses have gained a new avenue for fulfilling their information needs and have also brought great changes to the way consumers and businesses interact. The Internet, however, has also brought much frustration and confusion to the very same consumers. It has solved some age old problems but has created new ones. It has created an explosion of valuable information which makes it easier for consumers to find and obtain information, but it has also created an overload of irrelevant information as well.

Today, consumers looking for information typically do not have time to explore a large Web site, to sort through tens of thousands of search results, to wait for weeks to receive a brochure in the mail, or to be put on hold for a long time to speak to a company representative. Consumers want to be able to obtain the specific information they want, when they need it, without wasting time or effort. They also want their privacy and to be able to make requests anonymously. Moreover, they do not want to be bothered by telemarketing calls in response to simple information requests.

In response, companies are looking for ways to meet those consumer requests, which would lead to increased sales, better communications, and reduced costs. Companies are also looking for methods to track the effectiveness of their advertising and promotional dollars in a world where media is becoming more and more fractured. Companies need a method to measure both global and individual activities across practically all media, and have a need for meaningful reports that combine information from different media.

Known existing systems have been deficient in meeting these needs. For example, autoresponder systems have been developed to send information to interested parties through e-mail. These known systems have been deficient, for example, because they require users to remember many different and lengthy e-mail addresses for products or services of a number of different vendors, because they lack effective means for tracking advertisements across different media, because they require contacting several vendors to receive information on different products, etc.

### SUMMARY OF THE INVENTION

In accordance with the principles of the present invention, quick and efficient satisfaction of different information distribution needs for both information requestors and information disseminators may be met through a central information dissemination service. An information disseminator (e.g., a company seeking to disseminate information) may register with a central information dissemination service. The information disseminator may register an information address with the central information dissemination service. The information disseminator may associate specific information with the information address. The information address may be an electronic mail (“e-mail”) address at the information dissemination service. The information address may be presented to potentially interested parties through practically any suitable means.

Information requestors (e.g., individuals interested in obtaining information) may note an information address and send a message (e.g., send an e-mail) to the noted address at the central information dissemination service. The central information dissemination service may receive the message, which is sometimes referred to herein as an information request, and may automatically and expeditiously generate a responding message (e.g., an e-mail) that includes information associated with the information address. The responding message may be sent by the central information dissemination service to the originating address of the information request. Such messaging may involve electronic messaging such as sending e-mails or other e-mail type messages.

Information addresses may each have a base portion that may be kept fixed for practically every registered information addresses and may include a variable portion that is different for practically every registered information address. The fixed portion may be published (e.g., widely published) to make it easily recalled for use by information requestors. For example, the fixed portion may be published to such an extent as to make the fixed portion as easy to recall as it is easy to recall telephone information directory assistance (e.g., “411”). The variable portion may be published to show its association with a particular promotion and its association with an information dissemination service that uses the fixed portion.

Information disseminators may access the system through practically any suitable equipment that has sufficient processing and communications to support email. The central information dissemination service may include a central facility that may have various hardware and/or software suitable for supporting the capabilities discussed herein. The software may have been implemented on the hardware of the central facility to implement the central information dissemination service.

The central information dissemination service may track and generate reports on information and request dissemination activities. The central information dissemination service may assign a global code to each registered information address. The central information dissemination service may have an information disseminator database that stores information on the global code and stores other information. The information disseminator database may include information that is associated with each information address, which is used by the central information dissemination service to quickly create or retrieve specific messages in response to information requests.

An individual tracking code may be generated for each information request that is received. The central information dissemination service may have an information requestor database that stores individual tracking codes and further stores other information of particular information requests. The information disseminator database and information requestor database may be used in tracking dissemination activity and in generating reports. Information disseminators may be given access to the databases through a communications connection between the central information dissemination service and the equipment of information disseminators. The communications connection may give information disseminators the ability to post, delete, replace or update content.

Responses to information requests (e.g., e-mails) may be sent in a format that is determined to be suitable for the display capabilities of each particular information requestor. Responses may include text, graphics, links, additional e-mails, registered information addresses, etc. Links and/or information addresses in the responses may be used to obtain additional information from Web sites, the central information dissemination system or to purchase desired products or services. An information requestor's action in response to an email may be tracked by the central information dissemination service.

The central information dissemination service may have a screening process for registering information addresses. Information addresses or portions thereof that are requested to be registered may be screened for particular factors, such as whether a requested address has already been registered, whether a requested address contains profanity, whether the address is a premium address, or whether the address contains a famous trademark.

The central information dissemination service may examine incoming messages and may translate the addresses of the incoming messages to identify which account or information is associated with a particular address. If desired, the central information dissemination service may inform requestors in responding messages of a fee for information (or for products or services) and may provide the requestors with an opportunity to pay the fee.

In some embodiments, requests may be made by an information requestor by simply “clicking” on a banner or link that has been presented to the requestor. In response, a message may be automatically generated and/or sent, which includes the appropriate populated fields.

For example, when an enabled banner is “clicked,” a window for an e-mail may be displayed (e.g., displayed by an e-mail client application) that includes an addressee field that has been automatically populated with an appropriate information address. A user may simply select the send option for the e-mail to send the e-mail.

Messages sent in response to information requests may be created in a number of suitable ways. For example, an information disseminator may be permitted to choose or upload messages to the central information dissemination service for distribution, permitted to upload a template for messages to the central information dissemination service, or may be permitted to use an administrative area of the central information dissemination service to create a template. Templates may be used to generate messages for distribution. Templates may be used to automatically insert global and individual tracking codes (or other information) in messages in response to information requests. A unique symbol such as the “˜” symbol may be used to mark points in the template where codes are to be inserted. The symbol should have a characteristic that prevents the codes from being accidentally inserted in improper points in a template. An option may be included in responses that information requestors may select to receive follow up information or updates. If desired, the central information dissemination service may attach files to messages that are generated in response to information requests.

If desired, a number of different options may be provided to information requestors. An information requestor may be given an option to download a program to create an icon on the requestor's system that is used to streamline information requests. An information requestor may be given an option to setup a referral system. An information requestor may also be given an option to create a folder for storing responses to information requests. An information requestor may be given an option by the central information dissemination service and to access messages previously sent to that requestor.

If desired, an information disseminator may be provided with a number of different options. For example, an information disseminator may be given an option to upload information to the central information dissemination service or to use the central information dissemination service to send message requests solicited from means outside of the service.

Information disseminators may track advertisements for a product or service across different media. An information disseminator may register different information addresses to be used for advertising the same product or service through different media. When an information requestor responds to an advertisement, information on the source of the request may be collected.

### BRIEF DESCRIPTION OF THE DRAWINGS

Further features of the invention, its nature and various advantages will be more apparent from the following detailed description, taken in conjunction with the accompanying drawings in which like reference characters refer to like parts throughout, and in which:

FIG. 1 is a flow chart of illustrative steps that may be involved in distributing information through a central facility in accordance with the principles of the present invention;

FIG. 2 is a functional block diagram of an illustrative central information dissemination service in accordance with the principles of the present invention;

FIG. 3 is a flow chart of illustrative steps involved in registering information disseminators and tracking information requests in accordance with the principles of the present invention;

FIG. 4 is a flow chart of illustrative steps involved in tracking requests and distributing information in accordance with the principles of the present invention;

FIG. 5 is a flow chart of illustrative steps involved in tracking and ordering information in accordance with the principles of the present invention;

FIG. 6 is a flow chart of illustrative steps involved in translating information addresses in accordance with the principles of the present invention;

FIG. 7 is a flow chart of illustrative steps involved in generating messages in response to information requests in accordance with the principles of the present invention;

FIG. 8 is a flow chart of illustrative steps involved in generating messages that include links to other documents in accordance with the principles of the present invention;

FIG. 9 is a flow chart of illustrative steps involved in tracking or reporting message activity in accordance with the principles of the present invention;

FIG. 10 is a flow chart of illustrative steps involved in providing added functionality to the information dissemination service in accordance with the principles of the present invention;

FIG. 11 is a diagram of an illustrative e-mail message in accordance with the principles of the present invention;

FIG. 12 is a diagram of an illustrative advertisement that includes registered address information in accordance with the principles of the present invention;

FIG. 13 is a diagram of an illustrative article that includes registered address information in accordance with the principles of the present invention;

FIG. 14 is a diagram of an illustrative telephone directory page that includes registered address information in accordance with the principles of the present invention;

FIG. 15 is a cross-sectional view of a magnetic data storage medium encoded with a set of machine-executable instructions for performing the method according to the present invention; and

FIG. 16 is a cross-sectional view of an optically readable data storage medium encoded with a set of machine executable instructions for performing the method according to the present invention.

Skilled artisans will appreciate that some elements in certain FIGS. are illustrated for simplicity and clarity and have not necessarily been drawn to scale.

### DETAILED DESCRIPTION OF THE INVENTION

Individuals who are interested in obtaining particular information from organizations that are the source of the information may interact with a centralized service (a central information dissemination service) to quickly and efficiently meet their information needs. The centralized service may include a central facility. The central facility may include hardware and software. The software may be implemented on the hardware of the central facility to implement the service. For clarity and convenience, the centralized service is primarily discussed in the context of a central facility.

If desired, a software package may be implemented to provide the service. An information dissemination software application(s) that implements the service may be provided to different companies to implement the service at different central facilities to provide separate information dissemination services. The software applications may be implemented on different hardware platforms. The service may also be implemented as an application service provider (“ASP”) type service. These techniques will allow different companies to set up their own central information dissemination services. Companies that may implement the service may include information dissemination oriented companies and may include other types of businesses such as local stores, restaurants, etc. An information dissemination software application may be implemented at the central facility of one of these companies to provide an information dissemination service.

The service may have a general communications address (e.g., a top-level domain name) that is easily recalled from memory. Organizations who wish to distribute information may register with the service to obtain a unique account (e.g., an e-mail account) at the central facility. The account information (e.g., the information address of the account) may be published and interested individuals may quickly fulfill their information needs by sending a message (e.g., an e-mail) to a particular account at the central facility. The central facility may quickly respond to the message (e.g., send an e-mail) with appropriate information by recognizing the account to which the request was directed. Request activity may be tracked and reports may be generated.

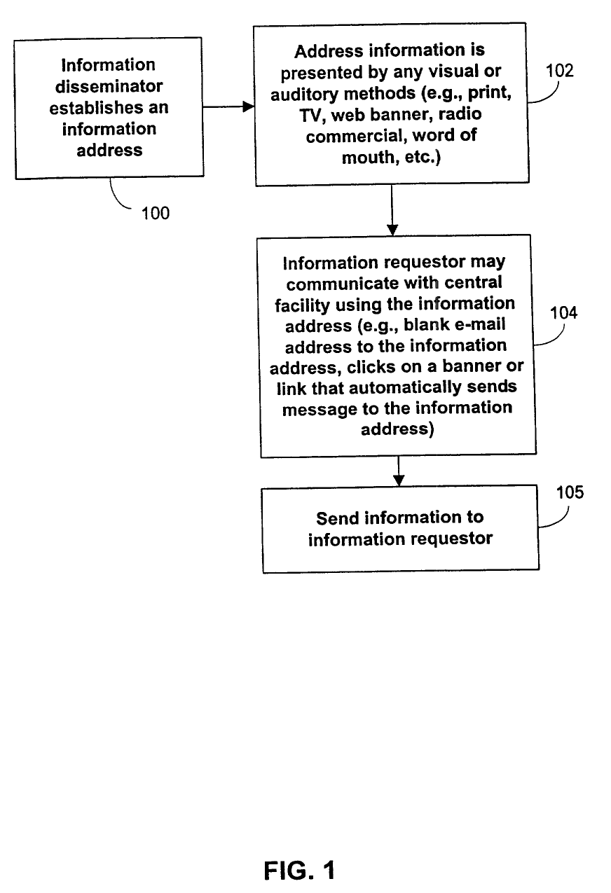

An information address of an account at the central facility may simply be the key for accessing information associated with the account. For example with reference now to FIG. 1, at step 100, an information disseminator, such as a product vendor, may establish an information address. The information address may be a unique address that the information disseminator has obtained through registration with the central facility. The information address may include a portion (e.g., a root portion) that is the base address for communicating with the central facility.

The base portion may be a fixed portion that remain practically the same (e.g., is the same) for practically every information address (e.g., for every information address) that is registered with the central facility. Other than the fixed portion, practically every information address may include a code portion that is varied to identify different information addressed at the central facility. The code portion may also be used to associate information with an information address that has been registered to disseminate that information. For example, an information address may be an Internet e-mail address having a second-level domain name that is associated with the central facility and having a prefix (a code portion) for a particular e-mail account at the central facility. Each registered information address may be a unique information address at the central facility. At step 100, an information disseminator may submit particular information, files, templates, or other materials that are to be associated with an information address or account for an information address.

At step 102, address information (e.g., information addresses, the fixed portion of addresses, the code portion of addresses, etc.) may be presented through audio or visual techniques to interested parties. Information addresses may be presented in practically any suitable way. Print, electronic, or broadcast media may be used to present information addresses. Information addresses may be presented visually or through audible notices. For example, an information address may be presented using broadcast techniques (e.g., television or radio), print media (e.g., newspapers, magazines, newsletters, posters, articles, books, etc.), direct marketing techniques (e.g., direct mail catalogs, postcards, flyers, package inserts, etc.), Internet based techniques (e.g., Web pages, e-mails, instant messages, chat rooms, forums, hyperlinks, newsgroups, search engines, etc.), physical displays (e.g., displays in stores, trade shows, concerts, etc.), outdoor signs (e.g., billboards, bus signs, real estate signs, etc.), directories (e.g., yellow pages, registers, etc.), enclosures (e.g., shopping bags, envelopes, polybags, etc.), recorded media (e.g., video, CDs, DVDs, cassettes, etc.), premiums (e.g., napkins, matchbooks, pens, mugs, etc.), products (e.g., milk cartons, T-shirts, soda cans, etc.), promotional products (e.g., stickers, magnets, calendars, etc.), and miscellaneous other techniques (e.g., kiosks, business cards, operating manuals, software, etc.). At step 102, a fixed portion of information addresses may be publicized to obtain brand recognition for the fixed portion and for its use as part of an information address. If desired, the fixed portion may be publicized to make that portion of information addresses to be ubiquitous, well known, and easily recalled from memory. This provides information requestors the convenience to only remember a code portion of an information address. Code portions may be also be publicized at step 102 to inform the public of the association of the code with a particular promotion and to inform the public of the association of the code with the fixed portion or the association of the code with the information dissemination service that uses the fixed portion.

At steps 100 and 102, an information disseminator may register different information addresses for the dissemination of essentially the same information and may present each of the different information addresses through different presentation means (e.g., different media). This will permit the information disseminator to track advertisements that have the same focus (e.g., advertisements for a single product) across several different types of media (e.g., print, radio, television, etc.). Reports may be generated for tracking the different advertisements. Tracking codes may be generated and used in responses to aid in tracking advertisements. Tracking codes and reports are further discussed below.

At step 104, an information requestor (e.g., someone who has noted the information address) may communicate with the central facility using a registered information address. The information requestor may communicate (e.g., send messages such as e-mails) with the central facility using communications equipment (e.g., software and/or hardware) that is suitable for communicating with the central facility. For example, the information requestor may send a blank e-mail to an information address at the central facility or, if desired, the information requestor may automatically enable a pre-addressed e-mail message to be sent to the central facility by “clicking” on a Web banner or by “clicking” on a link that is configured to automatically enable a pre-addressed email message to be sent (e.g., a blank e-mail) to the central facility. When an information requestor “clicks” on a banner or a link, an e-mail having appropriate addressing information may be presented to the information requestor that may be sent by the requestor by selecting a send option. Steps 100, 102, and 104 may therefore allow interested parties to quickly send an information request to a central facility. At step 105, a response to an information request may be sent that includes information, files, or other materials that are associated with an information address used to address the information request. For example, an e-mail may be sent that includes the information, files, or other materials. The addressor and addressee fields of the e-mail may have been automatically populated by the central facility. For example, the addressor field (e.g., the “from” field) may be populated with an address selected by an information disseminator and available from a local database such as an information disseminator database (discussed below).

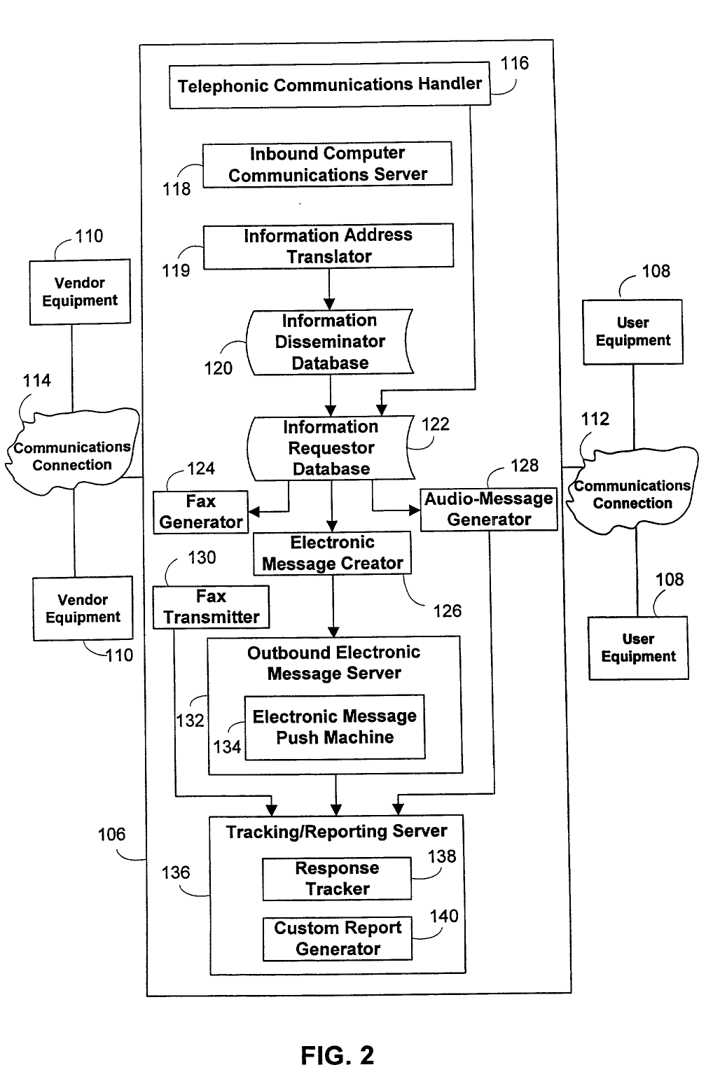

A central information dissemination service may be capable of receiving information requests and disseminating information in a number of different ways. For example with reference now to FIG. 2, central facility 106 may be configured to communicate with user equipment 108 and vendor equipment 110. User equipment 108 may be equipment that is used by information requestors to interact with central facility 106. Vendor equipment 110 may be equipment that is used by information disseminators to interact with central facility 106.

Central facility 106 may be capable of communicating with one or more types of user equipment 108. User equipment 108 may be a mainframe computer, a mini-computer, a micro-computer, a personal computer, a laptop computer, a palmtop computer, a personal digital assistant, a pager, a cellular telephone, a game console, a set-top box, etc. Other communications enabled devices (e.g., e-mail capable devices) may also be used. User equipment 108 may include equipment that supports telephonic communications with central facility 106, which may include conventional telephones, etc. In FIG. 2, a small number of instances of user equipment 108 is illustrated to avoid over-complicating the drawings.

If desired, user equipment 108 may include equipment used by retailers in performing transactions with customers. Retailers may enter a customer's e-mail address at checkout. The date, time, and bar code information for products may also be recorded. Central facility 106 may be used to send information and promotions corresponding to the bar codes to the customers (e.g., sent in a batch process)). If desired, information addresses corresponding to purchased products may be printed on customer receipts.

User equipment 108 may communicate with central facility 106 through communications connection 112. Communications connection 112 may practically be any suitable communications connection used for establishing communications between user equipment 108 and central facility 106. For example, communications connection 112 may include in part or in whole a wide area network, a local area network, the Internet, a public switched telephone network, a cellular telephone network, etc. User equipment 108 may be equipment on which software applications such as an e-mail client application has been implemented.

Central facility 106 may be capable of communicating with one or more types of vendor equipment 110. Vendor equipment 110 may be used to register with the central facility, to upload information to be disseminated by the central facility, and to receive reports and tracking information. Vendor equipment 110 may be a personal computer, a server, a main frame computer, etc. Vendor equipment 110 may practically be any type of equipment through which information disseminators may send, receive, or access information. Vendor equipment 110 may include an Internet communications capable device. Vendor equipment 110 may communicate with central facility 106 through communications connection 114. Appropriate software may have been implemented on vendor equipment 118. Communications connection 114 may practically be any suitable communications connection for establishing communications between vendor equipment 110 and central facility 106. For example, communications connection 114 may include in part or in whole, a wide area network, a local area network, the Internet, a public switched telephone network, a cellular telephone network, etc. If desired, communications connection 114 may include a direct connection with central facility 106. Communications connection 114 may be the same as communications connection 112. Vendors or information disseminators may communicate with central facility 106 though other techniques such as by corresponding using paper correspondence or electronic media.

Central facility 106 may provide a centralized streamlined information distribution service through which the public may obtain quick and reliable satisfaction of their information needs. Central facility 106 may include suitable hardware and/or software for providing some or all of the capabilities described herein. A central information dissemination service and/or central facility 106 of a central information dissemination service may be considered to be “central” in that different information requestors may request different information materials of different information disseminators using information addresses that each include a portion that is central to practically all of the information addresses by which the information dissemination process may be centralized. Illustrative hardware and/or software that is described herein to be part of central facility 106 and/or part of the information dissemination service may include some hardware and/or software that is not centrally located.

As mentioned above, an information disseminator may be an organization that is interested in disseminating information to interested parties. Information disseminators may wish to disseminate information in connection with a product or service that is offered by them. For example, a company such as a car maker may wish to disseminate information on a new car to individuals who have expressed an interest in that car. Another example may involve clothing designers and/or retailers who want to distribute information about a particular clothing item and to provide an avenue for the clothing item to be purchased. A further example may involve service providers such as computer training service providers that seek to disseminate information on their offered services to select individuals. Information disseminators (e.g., vendors of products or services) may have registered with central facility 106 by obtaining an information address from central facility 106 for particular information to be disseminated. Thus, a company such as the car maker company may register the information address “companynamenewcar@<centralfacility>.com or “newcar@<companyname>.<centralfacility>.com and may store information that is associated with that information address at central facility 106. The brackets “<” and “>” are being used herein to identify areas in e-mail addresses where actual domain name information is to be inserted.

Central facility 106 may include telephonic communications handler 116, inbound computer communications server 118, information address translator 119, information disseminator database 120, information requestor database 122, fax generator 124, electronic message creator 126, audio-message generator 128, fax communications transmitter 130, outbound electronic message server 132, and tracking/reporting server 136. Tracking/reporting server 136 may include response tracker 138 and report generator 140. Outbound electronic message server 132 may include electronic message push engine 134.

Information dissemination services are first discussed herein primarily in the context of electronic messaging such as electronic mail. For clarity and brevity, electronic messaging is discussed primarily in the context of Internet based communications techniques (e.g., Internet e-mail addressing, etc.). Electronic messaging in other forms may also be implemented.

As mentioned above, an information requestor may communicate with central facility 106 using an information address. For example, an information requestor may send a blank e-mail to a particular information address at central facility 106 or may activate a feature in a web browser that automatically enables a pre-addressed blank e-mail to a particular information address at central facility 106. A registered information address may essentially be used by the information requestor to e-mail prompt (e.g., “ping”) central facility 106 to generate appropriate information responses (e.g., e-mails). Inbound messages to central facility 106 may be received and handled by inbound computer communications server 118 (e.g., an inbound e-mail server). Inbound computer communications server 118 may be capable of receiving e-mail messages, instant messages, text messaging, etc. Inbound computer communications server 118 may receive inbound messages that have a root address or address extension that is associated with central facility 106 (e.g., “<centralfacility>.com”). Inbound computer communications server 118 may determine whether an incoming message is addressed to a registered information address at central facility 106. For example, inbound computer communications server 118 may check the prefix portion of an incoming e-mail (i.e., the portion before the “@” symbol in an Internet e-mail address) to determine whether the prefix has been registered as part of a information address at central facility 106. The system may allow information disseminators to register information addresses that include a requested prefix portion and a requested sub-domain portion (e.g., a portion after the “@” symbol that is before the second-level domain name, e.g., “<companyname>.<centralfacility>.com). In such address structures, communications server 118 may check the prefix portion and the sub-level domain name to determine whether a registered information address has been received. When an inbound message address does not match any one of the registered information addresses, central facility 106 may send a reply message informing the requestor that an appropriate match was not located. If desired, the reply message may provide the requestor with information on how to obtain a list of registered information addresses (e.g., by providing a link to an Internet site that includes the list) or if the information disseminator has set up a default document for a root address the default document may be sent.

Information address translator 119 may translate information contained in an information address. Information address translator 119 may translate an information address of an inbound message to identify appropriate information in a database, including such items as media source, time and date and other items which are available for capture. Other information that is available from the inbound message may be captured by information address translator 119. For example, information address translator 119 may translate “carmaker@<centralfacility>.com” into the address of a database record (e.g., record #211 ). The database address may be the address of an information record at central facility 106 for information submitted by a vendor (e.g., the car maker) for distribution when information requests to the registered information address or addresses associated with that record are received. Information address translator 119 may extract or examine a portion of a received information address to perform the translation. Additional techniques and procedures for information address translator 119 are discussed below.

An email, to a registered information address may be considered an information request. Information that can be captured from a message sent to central facility 106 may be stored in information requestor database 122. Information requestor database 122 may store certain information about substantially every information request that is received by central facility 106. A tracking code (e.g., a unique code) may be generated for each information request and information captured from each information request may be stored in association with the code. The code and the associated information may be stored in information requestor database 122. For example, for a message to “carmaker@<centralfacility>.com” from “customer@<customers>.com”, central facility 106 may generate code AFD33MK to uniquely identify that request and may store the code and the address of the requestor (“customer@<customer>.com”).

Information requestor database 122 may include a record for each information request that includes a number of different record fields. For example, the different record fields include a field for the originating address of the information request (e.g., the e-mail address of the information requestor), a field for the type of equipment used by the information requestor, a field for the code that was generated for the information request, a field for the day of the week of the information request, a field for the date of the information request, a field for the time of the information request, a field for the information address (or a portion of the information address (e.g., the prefix of the information address), a field for indicating whether a response sent for the information request has been opened, a field for the date and/or time that the response was opened, a field for the type of format in which the response was sent (e.g., HTML, text, etc.), a field for how many links in the response were “clicked” by the information requestor, a field for the addresses of the links that were “clicked” by the information requestor, a field for instructions for how to handle responses that are returned as undeliverable, and a field for instructions on how to handle further inquiries from an information requestor who has already received a response. The field for the type of equipment used by the reqeustor or for the identifying the capabilities of equipment used by the requestor may be determined when an application of the information disseminator service is used on the requestor's user equipment. If desired, such capabilities may also be determined using an application that resides with or is part of an application that provides an enabled link or banner that prepopulates an e-mail when a requestor selects the link or banner. Other fields may also be used and depending on the circumstances, not all of the fields may be populated or used.

An aggregate record may also be maintained in information requestor database 122. The aggregate record may hold information on the number of information requests that have been received, information on the number of responses that have been opened (e.g., originated by type, such as text e-mail, HTML e-mail, etc.), information on the percentage of responses that have been opened (e.g., originated by type, such as text e-mail, HTML e-mail, etc.), information on the number of links that were “clicked” by information requestors (e.g., organized by the address of the link), information on which links were “clicked” by information requestors, or information on an average number of links “clicked” per response. Other fields of information may also be used and depending on the circumstances, not all of the fields may be populated or used.

Information disseminator database 120 may hold materials that vendors or information disseminators have submitted to central facility 106 to distribute when a corresponding information address is received by central facility 106. Information disseminator database 120 may contain pre-recorded audio, contain information from which desired audio may be generated, contain text (e.g., for text for e-mails), contain non-text materials (e.g., graphics), contain information from which custom faxes may be generated, etc. Information disseminator database 120 may hold information that was submitted by an information disseminator to central facility 106 to have the information associated with a particular information address or associated with particular information addresses when the information disseminator registered with central facility 106.

Information disseminator database 120 may contain a list of registered information addresses (or relevant portions of addresses, e.g., the prefix). Information disseminator database 120 may contain information that a vendor desires to distribute in a particular format that can be quickly replicated for a number of different responses. For example, information may be stored in a template format in which particular fields in the format are automatically entered by central facility 106. For example, information disseminator database 120 may store a text e-mail message template and a non-text e-mail message template. If desired, central facility 106 may associate more than one information record with each information address.

Each registered information address may be associated with a number of fields in information disseminator database 120. Examples of general fields in information disseminator database 120 may include a filename for a text e-mail file that may initially be sent to an information requestor, a filename for an HTML e-mail file that may initially be sent to an information requestor, an indicator of whether to send follow up messages, and text for the entity name of the information disseminator. There may be sub-fields associated with the follow up message field, such as a field identifying the number of sequential messages to be sent, a field specifying the sequence, a field specifying a time between each message, a field specifying filenames for the messages.

Examples of more specific fields may include a field identifying the product or service involved, a field specifying the offer being made for a product or service, a field specifying whether the advertisement from which the information address was obtained was a broadcast advertisement, a field for the price, a field for the creative, a field for the date of publication, the date of airing, or the date of presentation, a field for the day of week for the publication, airing, or presentation, a field for the time of day of the airing, a field for the title of the advertisement, a field for the type of media used to publish, present, or air advertisement, a field for the size of the advertisement, a field for the position of the advertisement, a field for the cost of placing the advertisement, a field for identifying the circulation of the advertisement, a field for identifying the cost per thousand of the advertisement, a field for an Internet Web link associated with the advertisement, a field for an e-mail message to be sent for an expired offer, a field for identifying the offer expiration date, a field for identifying the quantity expiration of the offer, a field for the subject line of messages to be sent information requestors, a field for the final date on which the database record for that information address expires, a field for a message that will be sent when the final expiration date has passed, a field that may used to populate the “from” addressing field of a response to an information request, a field for whether database driven e-mails are provided, a field for information necessary for generating an e-mail to the central facility when database-driven e-mails are available, a field for whether payment information is being provided to information requestors, a field for the billing information when payment information is being provided to information requestors, a field for whether a “canned” text e-mail message or an e-mail template is being used, a field for a link to a template based e-mail builder, a field for whether an HTML e-mail or HTML e-mail template is being used, a field for a link to an HTML template based e-mail builder, etc.

Information disseminator database 120 may have fields that are specific to the media that was used to present or publish the information address such as a field for the publication or airing date, a field for the name of an article or segment that was used to publish or present the information address, a field for the name of the author, a field for the name of the producer, a field for an Internet Web link. An information requestor may specify a number of their own custom database fields in addition to the fields specified by central facility 106. Other fields may also be used and depending on the circumstances, not all of the fields may be populated or used.

In some information address structures, an information disseminator may be allowed to register a sub-level domain name (e.g., <companyname>.<centralfacility>.com) as part of the prefix portion of the information address. A default information document may be stored for dissemination when an e-mail to a registered sub-level domain is received that includes text before the “@” symbol that is not associated with particular information or valid information in information disseminator database 120. The registrant of that sub-level domain may be informed of the request activity.

The code and the information address (or part of the information, e.g., the prefix “carmaker”) for which the code was generated may be provided to electronic message creator 126. Electronic message creator 126 may have access to information in information requestor database 122 and may have access to information in information disseminator database 120. Electronic message creator 126 may use information about a particular information request and about a registered information address (e.g., information in information disseminator database 120 ) to create an electronic message response to the information request. Electronic message creator 126 may copy appropriate information such as the text or non-text template and insert information such as the code generated for the information request and/or the information address (or a portion of the information address, e.g., the prefix) into the template. Information may be automatically inserted by marking data entry points with a symbol such as the “˜” symbol. Different symbols may be used. Electronic message creator 126 may determine what type of content should be used (e.g., text, HTML, “canned” text, etc.) based possibly on information that may be available to electronic message creator 126 such as information contained in the address of the information requestor (e.g., based on the second level domain name of the address). Some addresses may indicate to the electronic message creator 126 that the equipment of the information requestor is HTML or graphics capable (e.g., customer@<ISP>.com” may indicate that the equipment of a requestor is graphics capable). Techniques and procedures for creating such electronic messages are further discussed below.

An electronic message that is created by electronic message creator 126 may be provided to outbound electronic message server 132 and to electronic message push engine 134. Electronic message push engine 134 may send the electronic message in response to an information request to the address that was received earlier in the information request. For example, electronic message creator 126 may create an e-mail containing information on a new car from Ford that is sent by electronic message push engine 134 to the e-mail address from which an information request was received. For example, electronic message push engine 134 may send an e-mail addressed to “customer@<consumer>.com” that includes information on a particular new car from a particular car maker when central facility receives an e-mail message from “customer@<consumer>.com' that is addressed to “carmakernewcar@<centralfacility>.com which may be the information address the car maker registered with the central facility to distribute information for that particular new car. Information from information requestor database 122 may be provided to tracking/reporting server 136. Tracking/reporting server 136 may include response tracker 138 and report generator 140 for generating suitable tracking and reporting information for information disseminators.

Messages may be formed or sent using techniques that return information or recipient activity to central facility 106. For example, a message may be sent in a way that causes a notification to be sent to electronic message push engine 134 or directly to tracking/reporting server 138 when the message is opened. Notifications may also include information on what level of non-text messages can be sent to the receiving address, and information on links in a message that were selected when the message was opened. Information that is received by electronic message push engine 134 may be provided or added to information requestor database 122 and tracking/reporting server 136.

Central facility 106 may be configured to give information disseminators access to information requestor database 122 from vendor equipment 110. An Internet browser connection or other type of communications connection may be established between vendor equipment 110 and central facility 106 to allow information disseminators to retrieve information from information requestor database 122. Also, in a similar manner, central facility 106 may be configured to have a communications connection with vendor equipment 110 for accessing or submitting information to information disseminator database 120. A central facility may assign an information disseminator rights to access information disseminator database 120 and/or information requestor database 122 when the information disseminator registers with central facility 106 or the information disseminator may be allowed to access only a specific area of information disseminator database 120 and/or information requestor database 122 depending on access levels or restrictions that have been assigned to the information disseminator.

Electronic messaging may not be the only techniques that central facility 106 may use to quickly disseminate information. If desired, fax generator 124 of central facility 106 and audio-message generator 128 may be used to distribute information in response to information requests. Telephone communications handler 116 of central facility 106 may be used to handle incoming telephone calls from information requestors. A central telephone number for central facility 106 may be called to access the distribution system (e.g., 800-555-3333). Telephone calls may be received from user equipment 108 such as cellular telephone, conventional telephones, etc. Specific telephone numbers may be assigned to specific information addresses so that a user does not have to key in an information address. The specific telephone numbers may also facilitate tracking. When a telephone call is connected, an information address (or a portion of an information address, e.g., the prefix of the address) that is registered with central facility 106 may be keyed in by the information requestor. Telephone communications handler 116 may obtain information about the requestor using techniques such as caller identification. As in the electronic messaging techniques discussed above, a tracking code may be generated for the information request and information captured from the information request may be stored in information requestor database 122. The process for telephonic information requests is essentially the same as for electronic messaging discussed above except possibly for the specific technique used for receiving and responding to address information from information requestors.

An information requestor accessing central facility 106 via telephonic communications may be given the option of receiving a response to their information request via telecopier or via audio message playback. When a telecopier response technique is used, fax generator 124 may create a fax file in a similar fashion as electronic message creator 126 creates an electronic message response. The fax file may be provided to fax communications transmitter 130 and transmitted to a telephone number that the requestor specified in the telephone call to central facility 106. Audio-message generator 128 may access a pre-recorded audio file that is available through information disseminator database 120 and may play back an audio from the file to the information requestor. The audio may include information similar to that which is provided in an electronic message or in a fax. If desired, central facility 106 may have sufficient equipment to generate a new audio message when an information request is received. Audio-message generator 128 and fax communications transmitter 130 may provide information or responses to tracking/reporting server 136 and/or to information requestor database 122 and/or to information disseminator database 120. Audio-message generator 128 may also automatically convert a text document from information disseminator database 120 into speech.

If desired, central facility 106 may be configured to check information disseminator database 120 to identify registered information addresses for which automatic follow up has been selected. Central facility 106 may send a response to a particular information request and may later check information disseminator database 120 to determine whether follow up messages should also be sent for that particular information request. If so, the process for sending electronic messages or other types of messages may be repeated.

The processes or methods that are illustratively described herein are processes or methods that can be implemented using the system, equipment, software, or other resources that are illustratively described in connection with FIG. 2.

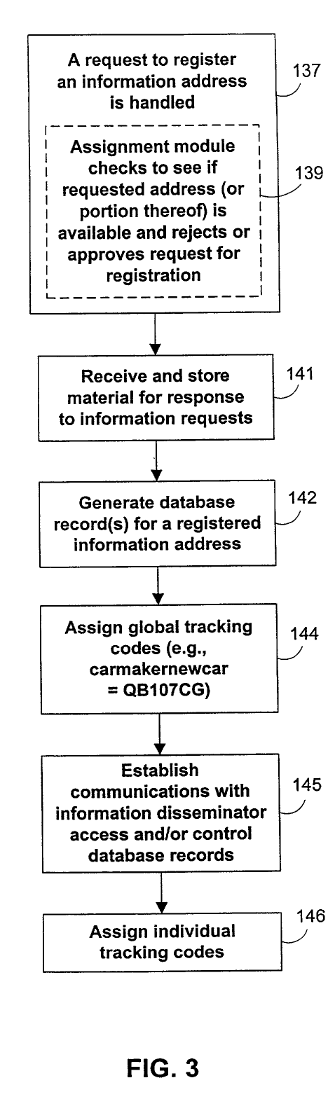

Illustrative steps involved in registering information disseminators and tracking information requests are shown in FIG. 3. With reference now to FIG. 3, at step 137, a central facility (e.g., central facility 106 of FIG. 2) may handle requests (e.g., receive requests) to register particular information addresses or register portions thereof. A request may be submitted by an information requestor to have information, such as marketing information associated with a desired information address, distributed to the requestor. At step 139, a central facility may run an assignment module that checks the requested information address or a relevant portion therefore (e.g., the prefix of an e-mail address) to determine whether to register the requested information address. Step 139 may involve using an information disseminator database (e.g., information disseminator database 120 of FIG. 2) to check if the requested information address or a relevant portion thereof has already been registered with the central facility. At step 139, the requested information address or relevant portion thereof may be otherwise examined to determine whether the requested address should be rejected or approved. The central facility may apply a filter to the request to reject address that contain well known brand names or trademarks. However, the filter may allow the actual owners of those brand names or trademarks to register their brand name or trademark as their information address or as part of their information address. Another filter may be a filter used to prevent reserved addresses or premium addresses (or portions thereof) to be registered. Premium information addresses (e.g., million, “411@centralfacility>.com”, etc.) may be addresses that the provider of the central facility may register at a higher fee than charged for other information addresses. For clarity and brevity, the term information address or a portion thereof will be sometimes referred to simply as an information address.

The central facility may also apply a filter to prevent certain types of words from being registered. Requests for information addresses that include profanity, hateful words, or other context-sensitive words (e.g., the word sex may be used in the context of Middlesex college) may be rejected. The central facility may generate a report perhaps on a daily basis to inform the operator of the system of the request activity. The operator may exercise further analysis of incoming requests.

If desired, steps 137 and/or 139 may be performed by a facility other than the central facility (e.g., a facility separate from the central facility). The resulting address information may be provided to the central facility for use in information dissemination.

At step 141, the central facility may receive and store material from an information disseminator that is used for preparing responses to information requests directed to a particular information address. As mentioned above, the material may be text, HTML, prerecorded audio, or other material that may be used to respond to information requests to a particular information address. If desired, receiving the message material may be part of the registration process so that an information address can be easily associated with the appropriate message materials. Information that is added to an information disseminator database by an information disseminator, including file attachments, may be scanned for computer viruses and/or inappropriate material.

If desired, step 141 may be performed by a facility other than the central facility (or separate from the central facility). If steps 137, 139, and 141 are not being performed directly be central facility, then a substantial portion of the registering information disseminators is being performed by equipment and/or resources other than the central facility.

At step 142, the central facility may create a database record(s) for use with the information address. The database record may be a record in an information disseminator database (e.g. information disseminator database 120 of FIG. 2). Potential information fields for such a record have been mentioned above. At step 144, a global tracking code (e.g., a unique tracking code) may be assigned by the central facility to the registered information address. The tracking code may include embedded information regarding information in the database record associated with the information address. The global tracking code may be an information management tool that the central facility and/or information disseminator may use to quickly access and/or organize information in connection with the information address.

At step 145, communications may be established between the central facility and an information disseminator who registered the information address (e.g., via vendor equipment 110 ). At step 145, communications may be established for the information disseminator to access, download, or change information in the database record associated with their information address. For example, the information disseminator may access the information disseminator database using an Internet Web page browser. If desired, an information disseminator may be permitted to delete a database record that is associated with their registered information address. At step 146, an individual tracking code may be assigned to an information request that is received at a central facility. An individual tracking code may be assigned to each received information request. If desired, the individual tracking code may be combined with the global tracking code to provide for efficient information management techniques.

Information can be communicated between central facility 106 and an information disseminator (e.g., via vendor equipment 110 ) through practically any suitable technique such as, manual entry into an Internet Web form, upload via File Transfer Protocol, upload via Internet Web form, export of database records, direct connections between databases, XML streaming of content, etc.

If desired, the central facility may be configured to check whether a new version of a database record exists in vendor equipment (e.g., vendor equipment 110 of FIG. 2) and may be configured to replace the stored record (e.g., a record in information disseminator database 120 ) with the new record. The central facility may allow information disseminators to setup custom data transfer options between the central facility and the vendor equipment. The custom data transfer options may apply selected filters or processes to database information before the information is made available to vendor equipment 110.

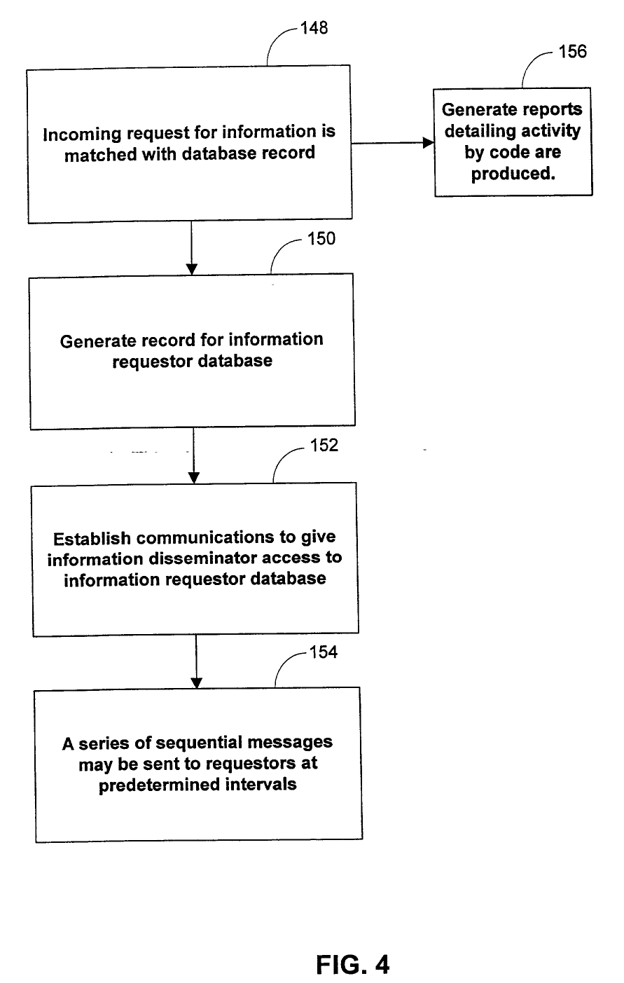

Illustrative steps involved in tracking requests and distributing information are shown in FIG. 4. With reference now to FIG. 4, at step 148, an incoming information request may be received and the information address for that information request may be matched with a record in an information disseminator database to retrieve appropriate information and/or materials for generating a response to the information request. At step 150, a database record may be created in an information requestor database (e.g., information requestor database 122 of FIG. 2) for the incoming information request. As mentioned above, particular fields in the database record may be populated based on information that is captured from the information request. At step 152, communications may be established between the central facility and an information disseminator (e.g., via vendor equipment 110) to give the information disseminator access to the information requestor database. For example, the information disseminator may access the information requestor database using an Internet Web page browser connection.

If desired, a series of sequential messages may be sent to information requestors at predetermined time intervals at step 154. This technique may be used to create an automatic customer relationship management system. At step 156, the central facility may generate reports detailing information on requestor and response activity. The reports may be produced using the global code or the individual tracking code so that the information may be meaningful to marketers.

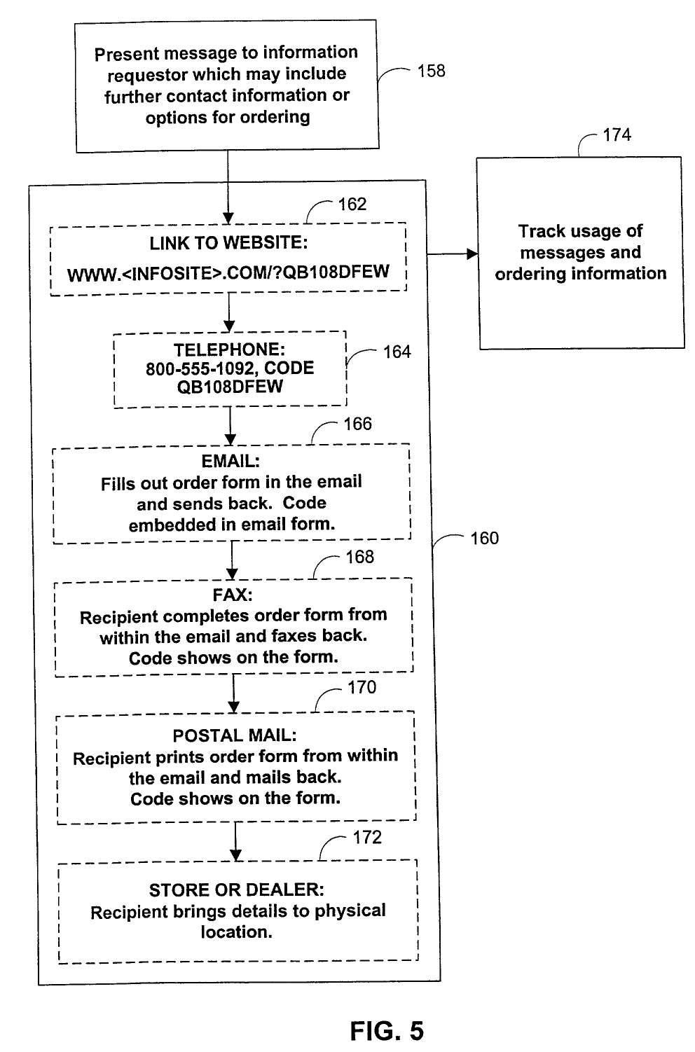

Illustrative steps involved in tracking and ordering information are shown in FIG. 5. With reference now to FIG. 5, at step 158, a message sent in response to an information request may be presented to an information requestor. As part of the message, contact information or user-selectable options may be presented to the information requestor. At step 160, the information requestor may initiate a communication using the contact information or options to order the product or service that is associated with the message. Step 160 may include steps 160, 162, 164, 166, 168, 170, and 172. At step 162, a link to an Internet Web site may be presented to the information requestor. The global code may be used in the address of the link to quickly bring the information requestor to a specific page on an appropriate Internet Web site for that product or service (e.g., “www.<vendor>.com/ABQDSRT” or “www.<vendor>.com/5XA922ZX”). An individual tracking code may also be used in the Web site address. The global code may also be used in an address of a link to a central facility. The code in the link may be used by the central facility to determine an appropriate web page address and to forward a user to that page. Information disseminators may have associated different web pages with different global tracking codes and/or with different information addresses to be used to direct information requestors to additional information on a desired subject.

At step 164, the information requestor may dial a telephone number that has been presented to the requestor for placing orders or obtaining more information. For such telephone interactions, the global code and/or individual tracking code of a response to an information request may be keyed in by the information requestor to quickly direct the information requestor to the appropriate extension or a unique phone number may be used that connects the information requestor directly to the requested information. At step 166, an order form that was included in the response may be completed by the user and sent by e-mail communications to place the order. A global tracking code and/or an individual tracking code may have been embedded in the order form. At step 168, an information requestor may complete an order form (e.g., by printing and completing the printed order form, by opening the order from in electronic form and completing it on a computer) that was included in the response to the information requestor and may fax the order form to an appropriate telephone address. The order form may include the global code and/or the individual tracking code. The user may also fill the form out on the computer and fax it directly from the computer if the computer is so equipped.

At step 170, an order form in the message sent to the information requestor may be printed and sent via postal mail to order a product or service. The order form may include the appropriate global code and/or individual tracking code. At step 172, information in the message may be used to locate a physical location for purchasing the product or service. The global code and/or individual tracking code may be requested from the information requestor when the requestor is at the physical location. At step 174, message usage and the ordering information (e.g., ordering information activity) may be tracked (e.g., tracked by the central facility).

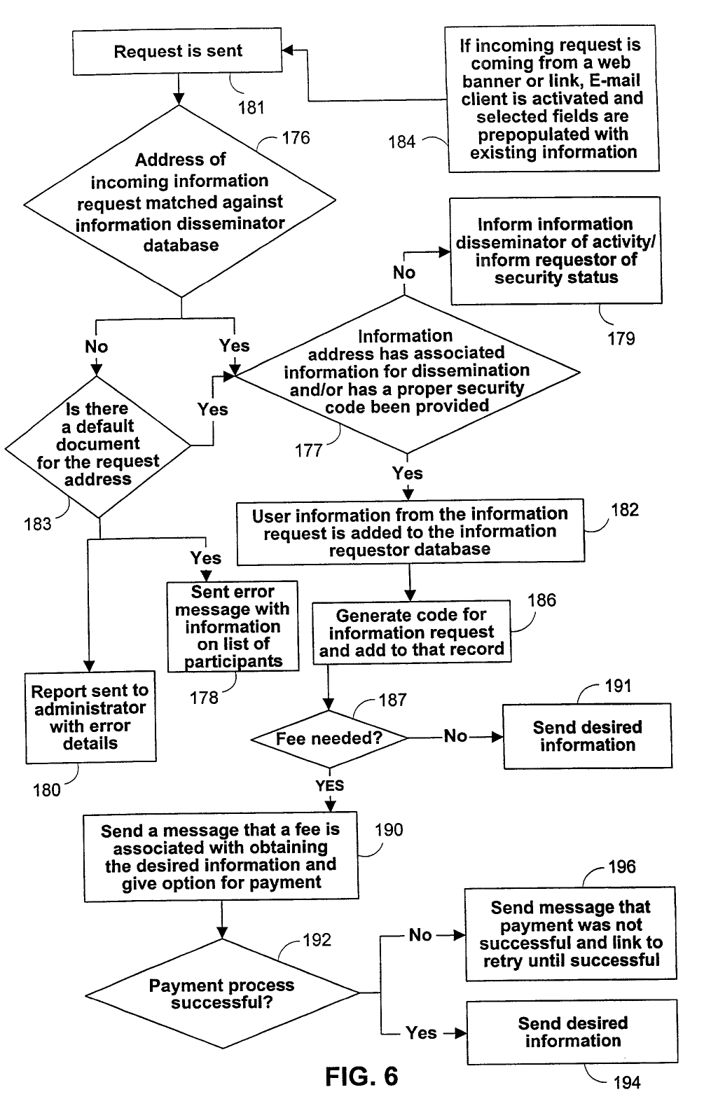

Illustrative steps involved in translating an address of an information request are shown in FIG. 6. With reference now to FIG. 6, at step 184, if desired, an information request may be automatically created by an e-mail client application and appropriate fields in an e-mail may be automatically populated when a user “clicks” on an enabled banner or link. In other situations, an information requestor may manually invoke an e-mail client application and may populate the appropriate fields. At step 181, an information request may be sent. At step 176, the address of an information request may be matched against an information disseminator database that stores a list of registered information addresses. At step 183, when a matching registered information address is not located, the address of the information request is examined to identify whether a default document has been setup by an information disseminator to handle requests sent to particular addresses. For example, an information disseminator may specify a default document for responding to e-mails that do not have a registered information address, but have sufficient address identifying information in the address portion of the e-mail (e.g., “<unregisteredaddress>@<companyname>.<centralfacility>.com”) to allow the e-mail to be associated with a particular default document. The process moves from step 183 to step 177 if there is a default document that can be assocaited with the information request. Otherwise, at step 178, an error message is sent back to an information requestor. The error message may include information on where a list of registered information addresses may be obtained. At step 180, error details are used to produce a report for a system operator. At step 182, if the incoming message information address matches a registered information address or if there is a matching sub-level domain address that has been registered, user information available from the information request may be added to an information requestor database. Default information associated with a registered sub-level domain name may be sent to an information requestor when a received information address only includes valid/registered domain name addressing.

At step 177, the central facility may determine if information (e.g., presently valid information) is available for the information address used in the request. If desired, at step 177, an information request may be examined to determine whether security information (e.g., a security code) that is needed to access desired information was included in the information request. For example, at step 181, an information requestor may have inserted a personal identification code or other security code in the subject field of an information request. The security information may be used to access information (e.g., credit card numbers, bank account numbers, etc.) that the information requestor stored remotely (e.g., stored at a central facility, stored at a third party provider that has an arrangement with the central facility) to be able obtain information from the central facility and/or a third party provider protected through security codes or passwords. If desired, at step 179, a response may be sent informing a requestor of the need for security information to be included in their information request or to inform that invalid security information was received. At step 179, an appropriate information disseminator may be informed of request activity for an information address that does not have associated information or that does not have currently valid information associated with the information address.

At step 186, the central facility may generate an individual tracking code for the current information request and may store the code in the information requestor database with information obtained at step 182. If desired, in some circumstances, the payment of a fee may be required of an information requestor. At step 187, the central facility may determine whether a fee is required for access to information that has been requested. At step 191, a message may be sent to respond to an information request with appropriate information when a fee is not required for the information. If a fee is required, at step 190, the central facility may send a message informing an information requestor of a fee for receiving the requested information when, for example, a “paid” content flag has been set to be active in an information disseminator database for the requested information. The message may also provide an option for paying the fee (e.g., through a link in the message to a third party Web site).

At step 192, information regarding whether the fee has been payed may be provided to the central facility. One technique for securing a fee for information, product, or services may be to include a link in an e-mail that will take an information requestor to a Web page through which the requestor may complete a transaction to pay a fee. A third party operator of the Web page may send an e-mail to the information dissemination to indicate that the fee has been paid. At step 194, a message for sending the information to the information requestor may be created and sent when payment has been made. At step 196, a message may be sent to the information requestor informing that the payment process has not been completed. This message may again include the electronic link to allow the payment process to be retried.

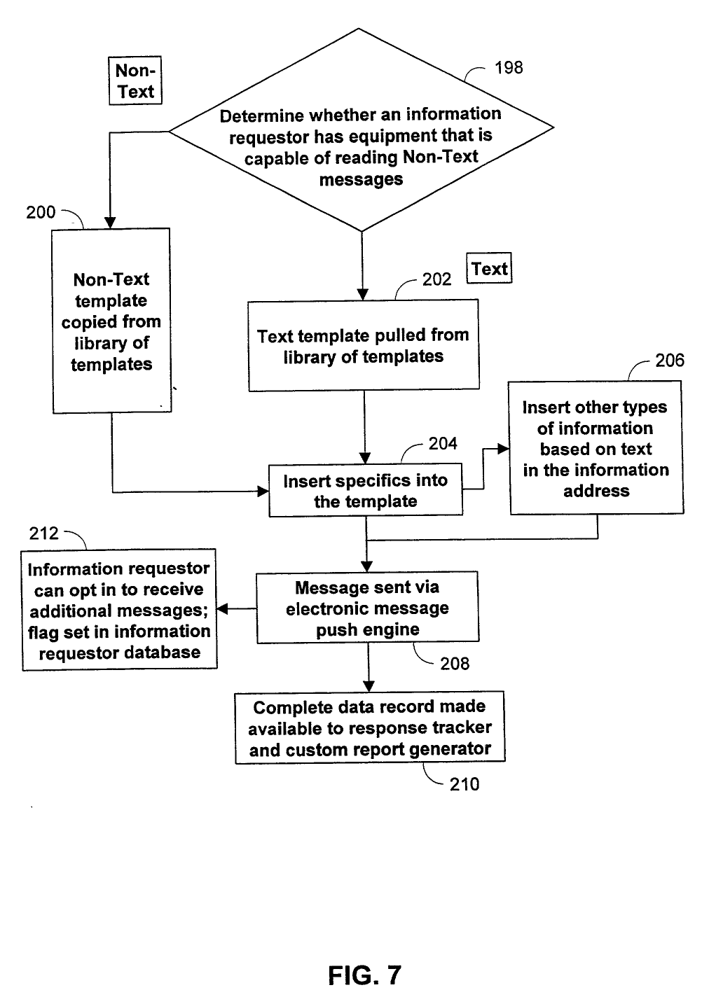

Illustrative steps involved in generating messages in response to information requests are shown in FIG. 7. With reference now to FIG. 7, at step 198, the central facility may examine information available to the central facility to determine whether an information requestor is using equipment that is capable of handling non-text messages (e.g., non-text e-mails). The capabilities of the equipment may for example be determined from the top-level domain name of the address from which an information request was sent or determined from information that is received by the central facility as part of the information request. In some circumstances where there is insufficient information to determine the capabilities of the equipment, the central facility may adopt a default setting (e.g., send non-text message).

At step 200, a non-text template may be retrieved from an information disseminator database (e.g., copied from a library of non-text templates in an information disseminator database) when the information requestor's equipment is determined to be non-text capable. At step 202, a text template may be retrieved from an information disseminator database (e.g., copied from a library of text templates in an information disseminator database) when the information requestor's equipment is determined to be text messaging capable. Templates that are retrieved may be templates that correspond to the information being requested by the information requestor.

At step 204, specific information may be inserted into appropriate points in a template. For example, the information address and an individual tracking code may be entered in select sections of a retrieved template.

If desired, a template may be used that includes promotional devices such as coupons. Global codes and/or individual tracking codes may be inserted into a promotional device (e.g., a membership card). The inserted code may further aid in tracking and monitoring marketing activity and may also aid in fraud protection.

At step 206, other types of information may be inserted into a template based on text in the information address of the information request. An appropriate database or server may be accessed to obtain appropriate information for insertion into the template. For example, the text “weather22101” in an information address of an information request may cause a weather database or weather information server to be accessed to obtain weather information that is automatically inserted into the template. Step 206 may also include a technique for inserting information on particular models of appliances (or machines) and distributing information on an individual appliance (or machines). For example, an information address may include the model number of a refrigerator (e.g., “AMANA45TLC@<centralfacility>.com”). A manual or other information for that model may be distributed by the central facility when the central facility receives a message to that address. Further by way of example, an information address may include the specific serial number of a particular refrigerator (e.g., “AMANA4560822294@<centralfacility>.com”). Specific information about that particular refrigerator may be distributed by the central facility when the central facility receives a message to that address. These messages may include both general information about the appliance maker that is inserted into a message based on the name of the appliance maker being in the information address and specific information that is based on the model or serial number of the appliance.

At step 208, a message created using a template may be sent to the information requestor. At step 210, data records associated with the message may be made available to a response tracker (e.g., response tracker 138 of FIG. 2) and/or a custom report generator (e.g., report generator 140 of FIG. 2).

At step 212, an information requestor that received the message that was sent at step 208 may select to receive additional follow up messages. For example, a message sent to an information requestor may include an electronic link that is selectable to indicate to the system that additional messages are desired. A flag may be set in an appropriate record in an information requestor database to indicate that additional messages should be sent to a particular requestor. In one configuration, the selection of this option is used to subscribe the information requestor to updates of requested information. For example, an information requestor may have sent an information request for a specific printer driver that the requestor may have received within seconds of placing the request. An update to that particular driver two months later may be automatically sent to that same information requestor. The information requestor may subscribe to an information address by “clicking” on a link in a message sent from the central facility. Other examples may include recipe files that change periodically, virus data files, restaurant menus, wholesaler's price lists, etc. The system may also permit information requestors to unsubscribe from this service.

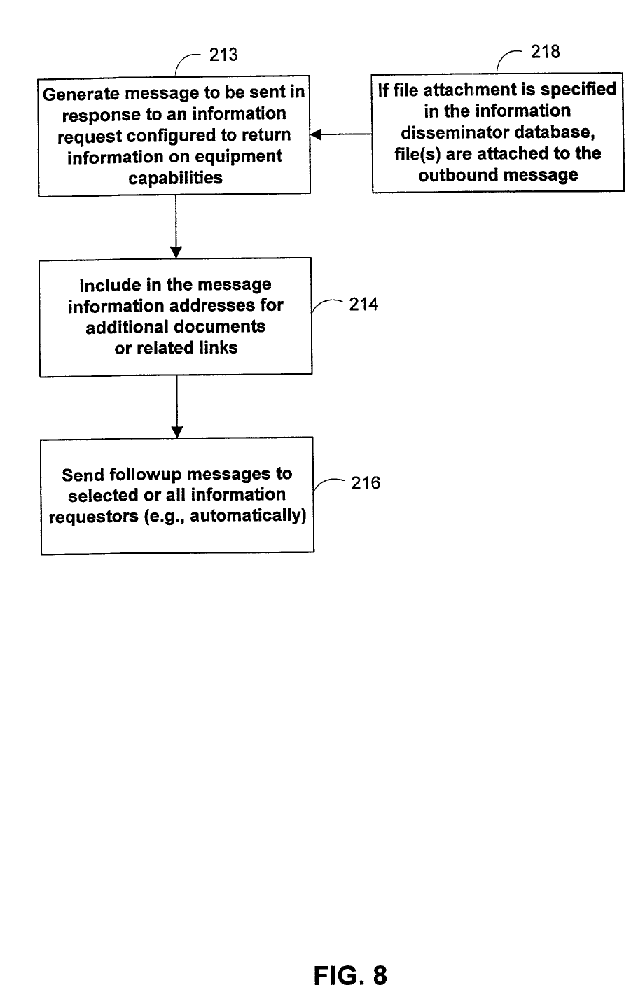

Illustrative steps involved in generating messages in response to information requests are shown in FIG. 8. With reference now to FIG. 8, at step 213, a message in response to an information request may be generated. The message may be formed using a technique that returns information to the sender of the message about message recipient activity. The sending equipment (e.g., outbound electronic message server 132 of FIG. 2) may receive information that may be used to determine the capabilities (e.g., text or non-text message capabilities) of the recipient's equipment (e.g., user equipment 108 of FIG. 2). At step 214, an information treeing technique may be implemented. Step 214 may involve inserting information addresses in the message to an information requestor. The information addresses may be presented in the message in a way that a viewer may simply “click” on an address to start the process of receiving information. At step 214, a link to a Web page such as a preference page may be included to present a Web page to an information requestor to sign up for additional information such as e-mail newsletters, alerts, promotions, coupons, recall information, etc.

At step 216, follow-up messages may be sent to some or all of the information requestors. An information disseminator may have instructed the central facility to send such follow up messages. At step 218, a file attachment that may have been specified to be sent with responses to information requests to a particular information address may be attached to the responses. Attachments may be software programs (or patches), printer (or other device) drivers, manuals, FAQs, sales information literature, operating manuals, price lists, product specifications, etc. The attachments may practically be in any suitable format such as in executable format, HTML format, PDF format, text format, word processor format, spreadsheet format, etc. Practically any type of file that can be attached may be sent with responses. This provides a convenient way for information requestors to automatically receive files without having to resort to manual downloading techniques (such as, downloading files from a Web page).

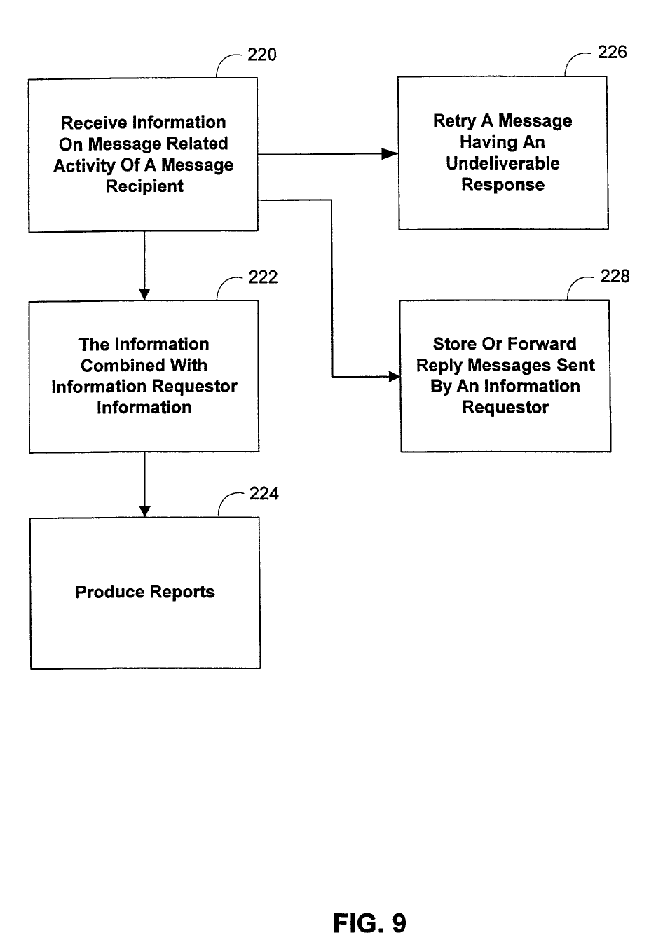

Illustrative steps involved in tracking or reporting message activity are shown in FIG. 9. With reference now to FIG. 9, at step 220, information related to message-usage activity may be received at a central facility. The information may be received and sent to a response tracker (e.g., response tracker 138 of FIG. 2). The information may indicate whether a message sent in response to an information request has been opened and/or whether links in the message have been activated by the recipient. At step 222, the information related to message-usage activity may be combined with information requestor information from information requestor database. Step 222 may further involve sending the combined set of information to a custom report generator (e.g., report generator 140 of FIG. 2).

At step 224, activity reports may be produced. The reports may be produced specifically using formats that are saved in an information disseminator database. A global activity report may be compiled to report on the total activity for each registered information address. For example, a response index report may be generated that informs an information disseminator of the cost-effectiveness of advertisements and/or registering an information address for the advertisement. The index report include the ratio of the cost over the number of information requests that have been received for a particular information address. An individual activity report may be produced to report on individual request activity. For example, an individual pattern tracking report may be generated based on individual information requests that have been received. The tracking report may contain information on one or more information requests including for example, time of reception of the request, originating e-mail address, etc. Each report can include information on a related group of information addresses (e.g., “carmakernewcarA@<centralfacility>.com” “carmakernewcarB@<centralfacility>.com”, and “carmakernewcarC@<centralfacility>.com”.

At step 224, a report may be generated for tracking an advertisement for a product or service across different forms of media (or different advertising sources such as different magazines) in which the advertisement was presented. Different information addresses may have been in different media to advertise the same product or service so that when someone responds, the source of the advertisement may be easily identified. Information disseminators may then track the effectiveness of different advertising, the effectiveness of different media, etc.

At step 226, the central facility may retry transmitting messages that were returned as being undeliverable. At step 228, messages that are sent by an information requestor in response to receiving information satisfying their original request may be stored at the central facility (e.g., archived) or may be forwarded to the appropriate information disseminator (i.e., the information disseminator whose information was sent to that particular recipient in response to an information request).

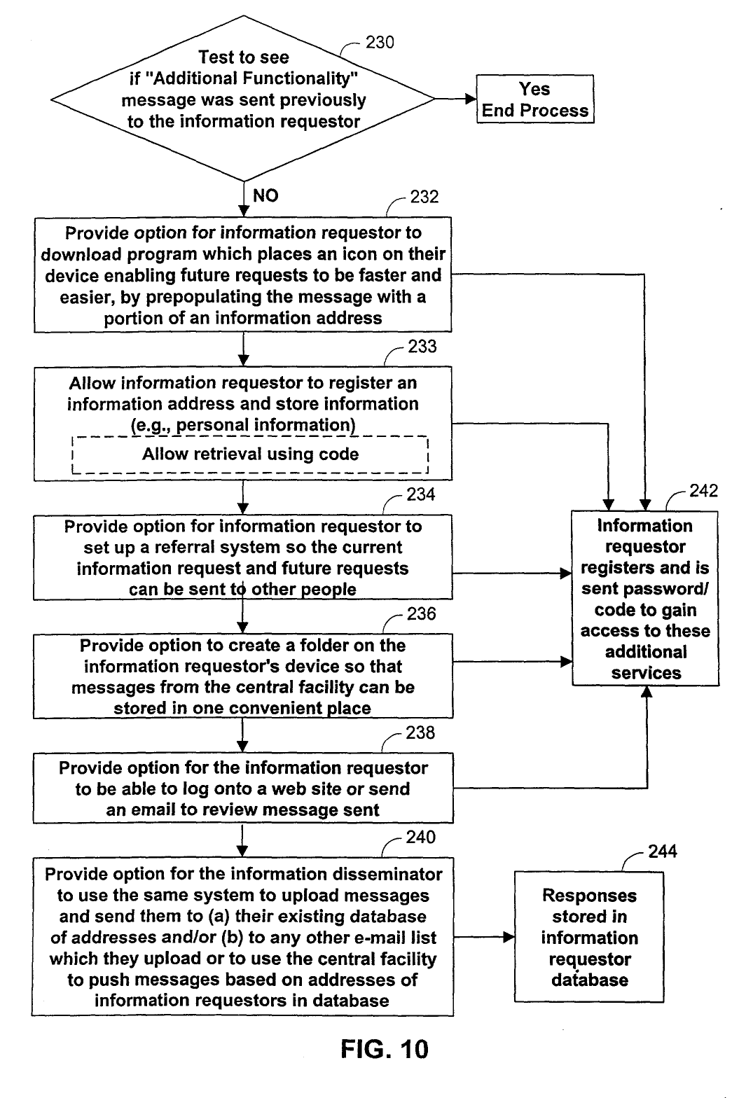

Illustrative steps involved in providing added functionality to the information dissemination service are shown in FIG. 10. A central facility may send a follow up message informing a user of the availability of additional functionality that may be provided by the service. With reference now to FIG. 10, the central facility may determine whether a follow up message regarding additional available functionality has already been sent to a particular address from which an information request was previously received. If the central facility determines that such a message has already been sent, then the process ends. Otherwise, the process may proceed to steps 232, 233, 234, 236, 238, 242, and 244. At step 232, an option to download a program that places an icon on an information requestor's equipment may be provided. The icon may be displayed and may be selectable to have the downloaded program automatically populate portions of an information request such as parts of the information address. This feature may make the information request process quicker.

At step 233, an information requestor may be given the option to register with the central facility (e.g., register through illustrative techniques shown herein for information disseminators) to store personal information for later access. The information may store personal private information such as credit card or bank account information. The information requestor may be required to use a security code when sending an information request for the information. The security code may be inserted in the subject field of an information request.

At step 234, an option to set up a referral system may be provided. When selected, the option may cause responses to current and/or future information requests to be sent to other people that have been specified by the requestor. At step 236, an option to create a folder on an information requestor's equipment may be provided. When this option is selected, messages from the central facility may be stored (e.g., automatically stored) in one convenient location in the user equipment of an information requestor and/or stored in a third party storage location indicated by the information requestor. At step 238, an option to give an information requestor access to information at the central facility may be provided. When this option is selected, an information requestor may be permitted to log into an Internet Web site of the central facility and may be authorized to retrieve any past messages that were sent by the central facility. If desired, at step 242, the option may be provided by assigning a particular information address to an information requestor that the requestor may use to receive an e-mail giving access to past e-mails. If desired, security protection may be used (e.g., a security code in the subject field may be used) to protect the information from being accessed by unauthorized individuals. At step 242, an information requestor who has selected one or more of these options (e.g., from a follow up e-mail) and who has registered with the central facility may be given a password or security code (e.g., a personal identification code) to gain access to desired ones of these options or to gain access to information having security protection. If desired, the password or code may be set by the requestor.

At step 240, an option may be provided to information disseminators to gain access to the messages that have been sent by the central facility. Information disseminators may be given access to a database of messages or a list of information requestor addresses stored at a central facility and may use those messages or addresses for their own purposes. Information disseminators may use the messages to distribute information based on their own customer list or based on other lists. If desired, step 240 may also include providing an option to information disseminators to have unsolicited messages or mass message distributions be sent by the central facility based on addresses of information requestors that the central facility has stored in an information requestor database. The messages may be sent to some or all of the addresses. An information disseminator may be permitted to upload messages to the central facility for use in such unsolicited or mass message distributions. The options described in connection with step 240 may therefore allow an automated “do it yourself” promotional message push system. Step 240 may be implemented irrespective of step 230.

At step 244, responses to the options in steps 232, 234, 236, and 238 are stored in an information requestor database at a central facility. If desired, only some of steps 232, 234, 236, 238, 240 may be performed. The order of steps 232, 234, 236, and 240 shown in FIG. 10 is presented for illustrative purposes.

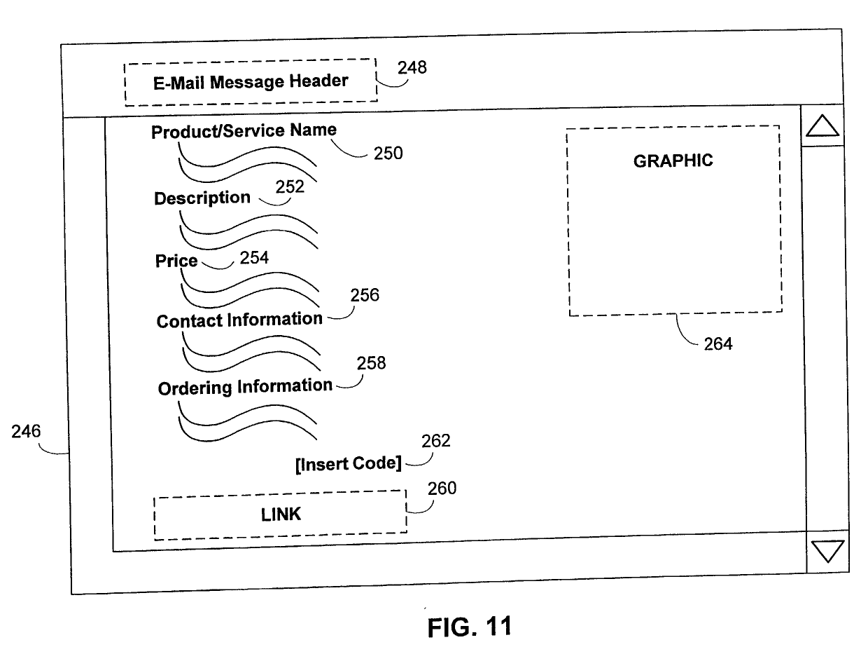

A response to an e-mail information request may be sent as an e-mail message to the e-mail address identified in the “from” field of the e-mail information request. The “to” field of the e-mail information request may contain an information address that has been registered with the central facility. An e-mail message sent in response to an information request may include various information and features. For example, with reference now to FIG. 11, illustrative e-mail message 246 may be representative of an e-mail message that was sent in response to an information request. E-mail message 246 may have been created using a template or may have been created using information that was simply copied into the message.

E-mail message 246 may include a number of different information fields. Each field may provide relevant information related to a product or service for which e-mail message 246 was sent to satisfy an information request. E-mail message 246 may include e-mail message header section 248 that may include an appropriate “subject” field. E-mail message 246 may include fields such as name of product or service 250, description 252, price 254, contact information 256, and ordering information 258. Information fields such as a field for contact information 256 or a field for ordering information 258 may include a selectable link such as selectable link 260. Selectable link 260 may be an Internet Web page hyperlink or other link that may be presented to the viewer. For example, selectable link 260 may be a hyperlink to a Web page of a third party that arranges for payments for products or services.

Template data insertion field 262 may have been included in e-mail message 246 when a template was used to create e-mail message 246. Data insertion field 262 may be used to automatically insert global or individual tracking codes into e-mail message 246. E-mail message 246 may include graphics portion 264. E-mail message 246 may include other fields or other combinations of fields. Other information that may be included in e-mail message 246 may include a feature description, a list of benefits specifications, availability, sizes, colors, intended uses, diagrams, photographs, shipping information, company information, help/support information, physical address location, mailing address, Web address, outlet locations, directions/maps, hours of operation, telephone numbers, personal contact information, terms/conditions/legal descriptions, information how to be cleared from the system, a promotional field (e.g., coupons, reviews, testimonials, list of other available information documents, etc.

The following is illustrative of a body a text format e-mail message that may be used in responding to requests:

| | |
|---|---|
| Company Name | |
| Company Name | |
| Company Name | Thanks for your request! |
| Company Name | |
| Company Name | We're pleased to present you with |
| Company Name | detailed information on the swimsuit |
| Company Name | that caught your eye! And if you decide |
| Company Name | to order, this email contains 6 easy |
| Company Name | and convenient ways to order! |
| Company Name | |
| Company Name | |

NATIVE COLOR-BLOCKED ONE-PIECE SWIMSUIT, PRINTED PAREO

Bring a touch of the islands home . . . with this stunning suit:

nylon/spandex blend for curves and comfort

shirring details at chest

flattering color-blocked style

updated smaller straps

hand wash

made in the U.S.A.

sizes: 6-8-10-12-14-16-18-20

colors: blue, berry

Priced right for summer: $34.99

Link for photo:

http://www.<companyname>.com/eb/product/100/EB10298-AFRETRD

COMPLETE THIS TROPICAL LOOK WITH THESE ACCESSORIES

PRINTED PAREO WRAP

100% cotton

waist-to-ankle coverage

hand wash

made in the U.S.A.

sizes: one fits all

colors: black, blue, olive, pink

Perfect addition to the native swim suit: $23.99

Link for photo:

http://www.<companyname>.com/eb/product/101/EB10928-AFRETRD

STRAW TOTE

woven straw-lined with cotton twill

leather handles

wood toggle closure on top

inside zip pocket

spot clean

imported

colors: natural

sizes: one size

Adds to a great look: $32.00

Link for photo:

http:/www.<companyname>.com/eb/product/102/EB10928-AFRETRD

BEACH SLIDES

made of durable EVA rubber

lightweight and flexible

flattering style with shorts and bathing suits

wipe clean

imported

sizes: 6M-7M-8M-9M-10M-11M-12M

colors: black, purple, white, pink, turquoise, yellow

Completes the look! $10.00

Link for photo:

http://www.<companyname>.com/eb/product/103/EB10928-AFRETRD

SPECIAL ENSEMBLE PRICE (4 items): $89.00 (you save $12)

6 EASY, FAST WAYS TO ORDER

PHONE:800-555-7935-Express Order Code EB 10928-AFRETRD

EMAIL: Highlight the order form below, hit REPLY, fill in your order, click SEND

WEB: click a product link and order on the web

FAX: print the order form, fill in and fax to 800-XXX-XXXX

MAIL: print the order form, fill in and mail to: Company Name, xxxxxxxxxxx, xxxxxxxxxxxxx, xx, xxxxx

STORE: send an email to EB10928S@<centralfacility>.com and in the subject line, type your zip code—so we can tell you the store that is closest to where you live

SPECIAL SERVICES & PROGRAMS

People just love our time-saving and thoughtful services . . . and they're all free! To get more information fast on our reminder service, sale notification alerts, new product announcements and much more, send a blank email to: services@eb.more.info OR click this link:

http://www.<companyname>.com/eb/services.htm/?EB10928-AFRETRD

------------------------------------------------------
QUICK 'N EASY ORDER FORM
------------------------------------------------------
BILL TO:
Name: _{————————————————————————————————}
Address: _{——————————————————————————————}
City: _{———————————————} State: _{——————————}
Zip: _{——————————} Country: _{——————————}
Email: _{————————————————————————————————}
Phone: _{————————————————————————————————}
SHIP TO (if different)
Name: _{————————————————————————————————}
Address: _{————————————————————————————————}
City: _{———————————————} State: _{——————————}
Zip: _{——————————} Country: _{——————————}

| QUANTITY | ITEM # | DESCRIPTION | SIZE | COLOR | PRICE EACH | TOTAL |
|---|---|---|---|---|---|---|
| [ ] | XXXXXXXX | Native 1 pc Swimsuit | [ ] | | 34.99 | $ |
| [ ] | XXXXXXXX | Pareo Wrap | N/A | | 23.99 | $ |
| [ ] | XXXXXXXX | Straw Tote | N/A | Natural | 32.00 | $ |
| [ ] | XXXXXXXX | Beach Slides | [ ] | | 10.00 | $ |
| [ ] | | Check if purchasing entire ensemble | | | 89.00 | $ |
| | | for $89.00 -- you save $12.00! | | | | |
| | | | | | TOTAL | $ |

Balance of order form, credit card information, etc.

Sign up for these free services!

[ ] Request a catalog

[ ] Monthly sale bulletins

[ ] Periodic closeout alerts

[ ] New product announcements

[ ] Women's fashion newsletter

[ ] Men's fashion newsletter

[ ] Information on an Eddie Bauer credit card

SC: EB10928-AFRETRD

The code “EB10928-AFRETRD” seen above may be a global code combined with an individual tracking code that has been inserted into the e-mail at selected spots.

The central facility may be configured to provide information disseminators with an administrative area that can be used to access their equipment (e.g. vendor equipment 110). The administrative area may make options available to information disseminator that can be used to build a message template. If desired, information disseminator may be given the option to upload their desired distribution messages or message templates to the central facility. The administrative area may also give information disseminators the option to generate information associated with a registered information address by copying information that is already associated with other registered information addresses.

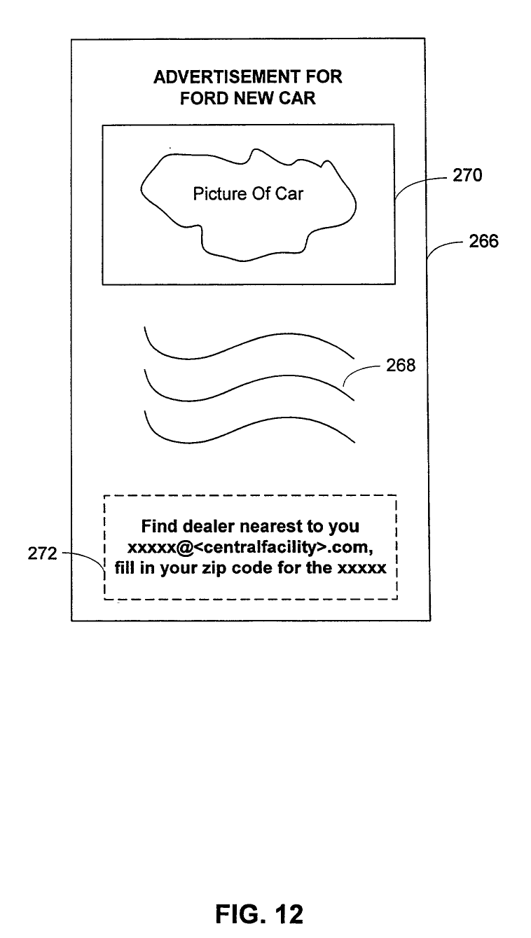

Information addresses described above that are used for receiving responses to information requests may be presented to particular individuals or to the general public in a number of different ways. For example, with reference now to FIG. 12, advertisement 266 for a new car may include promotional information such as text 268 and photograph 270. Advertisement 266 may also include section 272 that informs the user of a streamlined automated service for receiving information. As shown in FIG. 12, section 272 may inform the viewer that to find the nearest car dealership, the viewer may send an e-mail message to “XXXXX@<centralfacility>.com” and may use their postal zip code in place of the “XXXXX” in the address. In response, the viewer will receive an e-mail message providing a list of dealership in that viewer's local area.

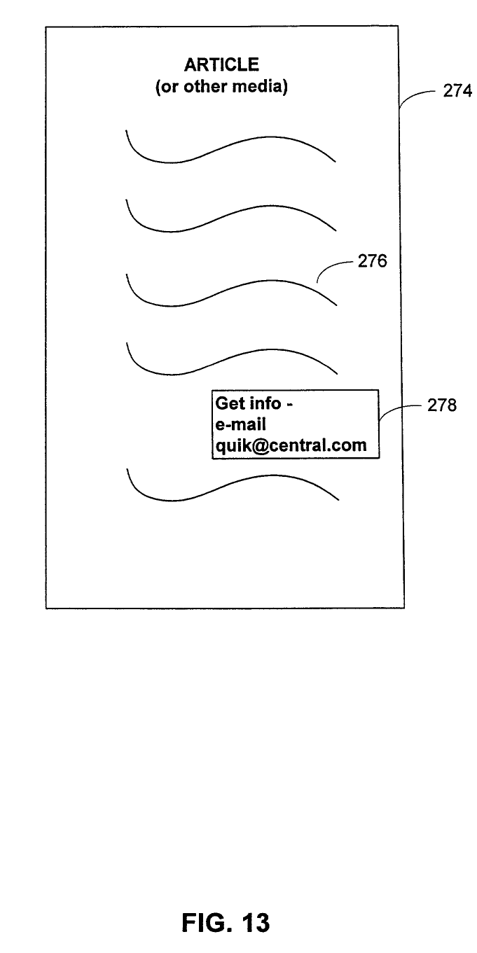

A registered information address may be published through media other than advertisements. For example, with reference now to FIG. 13, article 274 may include text 276 related to a particular subject. Article 274 may also include information address portion 278 that is presented to viewers to inform viewers of a service for obtaining information related to that article. Portion 278 may be presented as a part of the text of article 274 or may be presented separately set aside from the text.

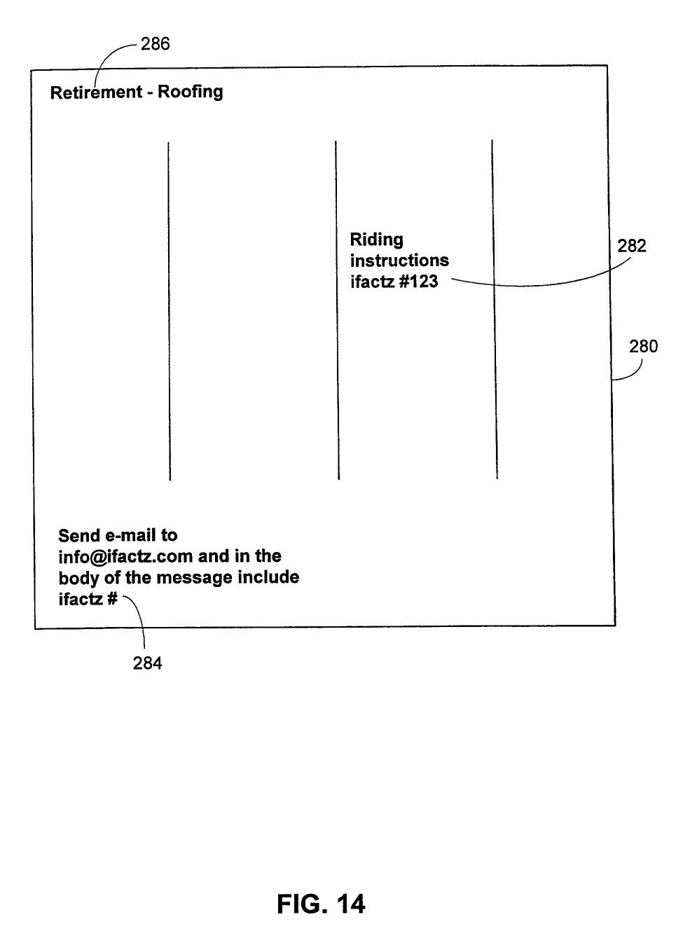

Another technique may involve including information about a registered address at a central facility in a directory such as a telephone directory. With reference now to FIG. 14, telephone directory page 280 may be a page in a telephone directory that includes information 286 for identifying what group of information is listed on page 280. Page 280 may display listing 282 about a registered information address in connection with a particular telephone listing on that page (e.g., Riding Instructions-IFACTZ #123). Page 280 may also include information 284 on how to use the registered information address. Viewers may insert the address into the body of an e-mail and send the e-mail to a universal address for all information requests. This may be one technique that may be used that is in addition to the above discussed techniques.

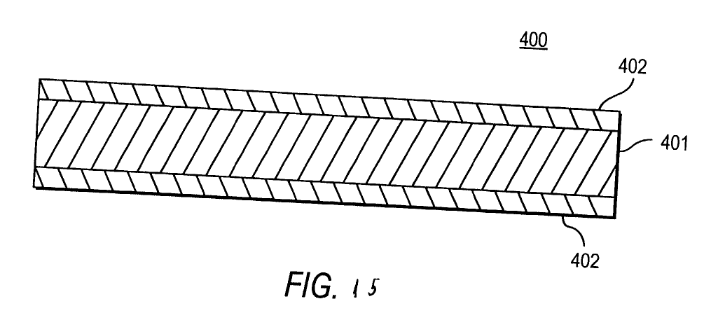

FIG. 15 presents a cross-section of a magnetic data storage medium 400 which can be encoded with a machine executable program that can be carried out by equipment such as central facility 106, user equipment 108, and/or vendor equipment 110 of FIG. 2 to implement methods discussed in connection with FIGS. 1-14. Medium 400 may be a storage device of central facility 106, user equipment 108, and/or vendor equipment 110 of FIG. 2. Medium 400 can be floppy diskette or hard disk, having a suitable substrate 401, which may be conventional, and a suitable coating 402, which may be conventional, on one or both sides, containing magnetic domains (not visible) whose polarity or orientation can be altered magnetically. Medium 400 may also have an opening (not shown) for receiving the spindle of a disk drive or other data storage device.

The magnetic domains of coating 402 of medium 400 are polarized or oriented so as to encode, in manner which may be conventional, a machine-executable program such as those described above in connection with FIGS. 1-14, for execution by equipment such as central facility 106, user equipment 108, and/or vendor equipment 110 of FIG. 1.

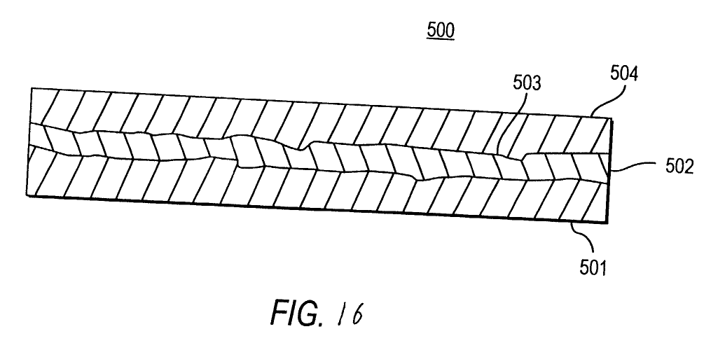

FIG. 16 shows a cross-section of an optically-readable data storage medium 500 which also can be encoded with such a machine-executable program, which can be carried out by equipment such as central facility 106, user equipment 108, and/or vendor equipment 110 of FIG. 2. Medium 500 can be a conventional compact disk read only memory (CD-ROM), a digital versatile disk (DVD), or a rewritable medium such as a CD-R or CD-RW disk or a magneto-optical disk which is optically readable and magneto-optically writeable. Medium 500 preferably has a suitable substrate 501, which may be conventional, and a suitable coating 502, which may be conventional, usually on one side of substrate 501.

In the case of a CD-ROM, as is well known, coating 502 is reflective and is impressed with a plurality of pits 503 to encode the machine-executable program. The arrangement of pits is read by reflecting laser light off the surface of coating 502. A protective coating 504, which preferably is substantially transparent, is provided on top of coating 502.

In the case of magneto-optical disk, as is well known, coating 502 has no pits 503, but has a plurality of magnetic domains whose polarity or orientation can be changed magnetically when heated above a certain temperature, as by a laser (not shown). The orientation of the domains can be read by measuring the polarization of laser light reflected from coating 502. The arrangement of the domains encodes the program as described above.

Thus, a streamlined, centralized, and efficient information distribution service may be provided to suitably meet the needs of both information disseminators and information requestors.

The foregoing is merely illustrative of the principles of this invention and various modifications can be made by those skilled in the art without departing from the scope and spirit of the invention.

What is claimed is

1. A method for providing a central information dissemination service that makes information available to the public, comprising:
registering electronic mail addresses at a central facility for different information disseminators that distribute promotional information;
storing, in a database at the central facility, the promotional information for each information disseminator in association with the electronic mail address of that information disseminator;
receiving an incoming electronic mail at the central facility, said incoming electronic mail addressed to one of the registered electronic mail addresses; and
creating in response to the incoming electronic mail, an outgoing electronic mail that is based on the promotional information associated with the registered electronic mail address of said incoming electronic mail.

2. The method of claim 1 further comprising publishing said one of the registered electronic mail addresses to inform the public of the availability of the promotional information that is associated with said one of the registered electronic mail addresses.

3. The method of claim 1 further comprising tracking activity of the registered electronic mail addresses.

4. The method of claim 1 further comprising assigning a global tracking code to each registered electronic mail address

5. The method of claim 1 further comprising assigning an individual tracking code to the incoming electronic mail.

6. The method of claim 1 wherein the registering comprises registering different electronic mail addresses for one of said information disseminators that are each to be used for different advertisements having the same focus.

7. The method of claim 6 further comprises assigning a tracking code to each of said different electronic mail addresses that are to be used for said different advertisements having the same focus to track activity of said different electronic mail addresses across the different advertisements.

8. The method of claim 6 wherein the registering different electronic mail addresses comprises presenting said different advertisements to through different media.

9. The method of claim 8 further comprises assigning a tracking code to each of said different electronic mail addresses that are to be used for said different advertisements having the same focus to track activity of said different electronic mail addresses across the different media.

10. The method of claim 1 further comprising generating a report based on receiving said incoming electronic mail.

11. The method of claim 1 further comprising generating a report based on how many of said incoming electronic mails have been received that are addressed to said one of the registered electronic mail addresses.

12. The method of claim 1 further comprising receiving requests to register said electronic mail addresses.

13. The method of claim 12 further comprising screening said requests.

14. The method of claim 1 further comprising sending said outgoing electronic mail.

15. The method of claim 14 further comprising sending a follow-up electronic mail to said one of the electronic mail addresses.

16. The method of claim 1 further comprising sending a fee required electronic mail that includes a link for paying a fee to receive said outgoing electronic mail.

17. The method of claim 1 wherein the creating comprises including an order form in said outgoing electronic mail.

18. The method of claim 1 further comprising displaying an electronic banner that can be selected to automatically create said incoming electronic mail.

19. The method of claim 1 further comprising displaying an electronic link that can be selected to automatically create said incoming electronic mail.

20. The method of claim 1 further comprising providing to an information requestor that sent said incoming electronic mail, a selectable option for downloading a software program that displays a selectable icon that automatically populates a portion of an electronic mail address field.

21. The method of claim 1 further comprising providing to an information requestor that sent said incoming electronic mail, a selectable option for referring future ones of said outgoing electronic mail to other electronic mail addresses.

22. The method of claim 1 further comprising providing to an information requestor that sent said incoming electronic mail, a selectable option to store personal information at the central facility.

23. The method of claim 1 further comprising providing to an information requestor that sent said incoming electronic mail from their user equipment, a selectable option for creating a folder for storing said outgoing electronic mail on said user equipment.

24. The method of claim 1 further comprising logging an information requestor that sent said incoming electronic mail into the central facility to review said outgoing electronic mail.

25. The method of claim 1 further comprising providing to an information requestor that sent said incoming electronic mail, a selectable option to receive access to past ones of said outgoing electronic mail.

26. The method of claim 1 further comprising determining whether user equipment from which said incoming electronic mail was sent is capable of displaying graphics in said outgoing electronic mail.

27. The method of claim 1 wherein the creating comprises including graphics in said outgoing electronic mail.

28. The method of claim 1 further comprising attaching a file to said outgoing electronic mail.

29. The method of claim 1 further comprising receiving the promotional information for one of said information disseminators for storing the promotional information in said database.

30. The method of claim 1 further comprising giving the information disseminators access to said database.

31. The method of claim 1 further comprising:
generating cumulative tracking information for said one of said registered electronic mail addresses; and
forming a communications connection with one of said information disseminators to access the cumulative tracking information.

32. The method of claim 1 further comprising:
generating tracking information for said incoming electronic mail; and
forming a communications connection with one of said information disseminators to access the cumulative tracking information.

33. The method of claim 1 wherein the creating comprises configuring said outgoing electronic mail to return information on actions taken when said outgoing electronic mail is received.

34. The method of claim 1 wherein the receiving comprises receiving said incoming electronic mail that includes a security code.

35. The method of claim 1 wherein the storing comprises providing in the promotional information for one of said information disseminators an electronic mail template.

36. The method of claim 34 wherein the creating comprises using said electronic mail template to create said outgoing electronic mail.

37. The method of claim 35 wherein the creating comprises inserting an individual tracking code in portions of said electronic mail template to create said outgoing electronic mail.

38. The method of claim 35 wherein the creating comprises inserting in said electronic mail template an individual tracking code to replace instances of symbol “˜” in said electronic mail template.

39. A central information dissemination system that makes information available to the public, comprising:
means for registering electronic mail addresses at a central facility for different information disseminators that distribute promotional information;
means for storing, in a database at the central facility, the promotional information for each information disseminator in association with the electronic mail address of that information disseminator;
means for receiving an incoming electronic mail at the central facility, said incoming electronic mail addressed to one of the registered electronic mail addresses; and
means for creating in response to the incoming electronic mail, an outgoing electronic mail that is based on the promotional information associated with the registered electronic mail address of said incoming electronic mail.

40. The system of claim 36 further comprising means for publishing said one of the registered electronic mail addresses to inform the public of the availability of the promotional information that is associated with that one of the registered electronic mail addresses.

41. The system of claim 36 further comprising means for tracking activity of the registered electronic mail addresses.

42. The system of claim 36 further comprising means for assigning a global tracking code to each registered electronic mail address

43. The system of claim 36 further comprising means for assigning an individual tracking code to the incoming electronic mail.

44. The system of claim 36 wherein the means for registering comprises means for registering different electronic mail addresses for one of said information disseminators that are each to be used for different advertisements having the same focus.

45. The system of claim 44 further comprises means for assigning a tracking code to each of said different electronic mail addresses that are to be used for said different advertisements having the same focus to track activity of said different electronic mail addresses across the different advertisements.

46. The system of claim 44 wherein the means for registering different electronic mail addresses comprises means for presenting said different advertisements through different media.

47. The system of claim 46 further comprises means for assigning a tracking code to each of said different electronic mail addresses that are to be used for said different advertisements having the same focus to track activity of said different electronic mail addresses across the different media.

48. The system of claim 36 further comprising means for generating a report based on receiving said incoming electronic mail.

49. The system of claim 36 further comprising means for generating a report based on how many of said incoming electronic mails have been received that are addressed to said one of the registered electronic mail addresses.

50. The system of claim 36 further comprising means for receiving requests to register said electronic mail addresses.

51. The system of claim 50 further comprising means for screening said requests.

52. The system of claim 36 further comprising means for sending said outgoing electronic mail.

53. The system of claim 52 further comprising means for sending a follow-up electronic mail to said one of the electronic mail addresses.

54. The system of claim 36 further comprising means for sending a fee required electronic mail that includes a link for paying a fee to receive said outgoing electronic mail.

55. The system of claim 36 wherein the means for creating comprises means for including an order form in said outgoing electronic mail.

56. The system of claim 36 further comprising means for displaying an electronic banner that can be selected to automatically create said incoming electronic mail.

57. The system of claim 36 further comprising means for displaying an electronic link that can be selected to automatically create said incoming electronic mail.

58. The system of claim 36 further comprising means for providing to an information requestor that sent said incoming electronic mail, a selectable option for downloading a software program that displays a selectable icon that automatically populates a portion of an electronic mail address field.

59. The system of claim 36 further comprising means for providing to an information requestor that sent said incoming electronic mail, a selectable option for referring future ones of said outgoing electronic mail to other electronic mail addresses.

60. The system of claim 36 further comprising means for providing to an information requestor that sent said incoming electronic mail, a selectable option to store personal information at the central facility.

61. The system of claim 36 further comprising means for providing to an information requestor that sent said incoming electronic mail from their user equipment, a selectable option for creating a folder for storing said outgoing electronic mail on said user equipment.

62. The system of claim 36 further comprising means for logging an information requestor that sent said incoming electronic mail into the central facility to review said outgoing electronic mail.

63. The system of claim 36 further comprising means for providing to an information requestor that sent said incoming electronic mail, a selectable option to receive access to past ones of said outgoing electronic mail.

64. The system of claim 36 further comprising means for determining whether user equipment from which said incoming electronic mail was sent is capable of displaying graphics in said outgoing electronic mail.

65. The system of claim 36 wherein the means for creating comprises means for including graphics in said outgoing electronic mail.

66. The system of claim 36 further comprising means for attaching a file to said outgoing electronic mail.

67. The system of claim 36 further comprising means for receiving the promotional information for one of said information disseminators for storing the promotional information in said database.

68. The system of claim 36 further comprising means for giving the information disseminators access to said database.

69. The system of claim 36 further comprising:
means for generating cumulative tracking information for said one of said registered electronic mail addresses; and
means for forming a communications connection with one of said information disseminators to access the cumulative tracking information.

70. The system of claim 36 further comprising:
means for generating tracking information for said incoming electronic mail; and
means for forming a communications connection with one of said information disseminators to access the cumulative tracking information.

71. The system of claim 36 wherein the means for creating comprises means for configuring said outgoing electronic mail to return information on actions taken when said outgoing electronic mail is received.

72. The system of claim 36 wherein the means for receiving comprises means for receiving said incoming electronic mail that includes a security code.

73. The system of claim 36 wherein the means for storing comprises means for including in the promotional information for one of said information disseminators an electronic mail template.

74. The system of claim 73 wherein the means for creating comprises means for using said electronic mail template to create said outgoing electronic mail.

75. The system of claim 74 wherein the means for creating comprises means for inserting an individual tracking code in portions of said electronic mail template to create said outgoing electronic mail.

76. The system of claim 74 wherein the means for creating comprises means for inserting in said electronic mail template an individual tracking code to replace instances of symbol “˜” in said electronic mail template.

77. A central information dissemination system that makes information available to the public, comprising a central facility at which an information dissemination software application has been implemented to configure the central facility to:
register electronic mail addresses at for different information disseminators that distribute promotional information;
store, in a database at the central facility, the promotional information for each information disseminator in association with the electronic mail address of that information disseminator;
receive an incoming electronic mail, said incoming electronic mail addressed to one of the registered electronic mail addresses; and
create in response to the incoming electronic mail, an outgoing electronic mail that is based on the promotional information associated with the registered electronic mail address of said incoming electronic mail.

78. The system of claim 77 further comprises media used to publish said one of the registered electronic mail addresses to inform the public of the availability of the promotional information that is associated with that one of the registered electronic mail addresses.

79. The system of claim 77 wherein the central facility is configured to track activity of the registered electronic mail addresses.

80. The system of claim 77 wherein the central facility is configured to assign a global tracking code to each registered electronic mail address

81. The system of claim 77 wherein the central facility is configured to assign an individual tracking code to the incoming electronic mail.

82. The system of claim 77 wherein the central facility is configured to register different electronic mail addresses for one of said information disseminators that are each to be used for different advertisements having the same focus.

83. The system of claim 82 wherein the central facility is configured to assign a tracking code to each of said different electronic mail addresses that are to be used for said different advertisements having the same focus to track activity of said different electronic mail addresses across the different advertisements.

84. The system of claim 82 further comprising different media used for publishing each of said different advertisements.

85. The system of claim 84 wherein the central facility is configured to assign a tracking code to each of said different electronic mail addresses that are to be used for said different advertisements having the same focus to track activity of said different electronic mail addresses across the different media.

86. The system of claim 77 wherein the central facility is configured to generate a report based on receiving said incoming electronic mail.

87. The system of claim 77 wherein the central facility is configured to generate a report based on how many of said incoming electronic mails have been received that are addressed to said one of the registered electronic mail addresses.

88. The system of claim 77 wherein the central facility is configured to receive requests to register said electronic mail addresses.

89. The system of claim 88 wherein the central facility is configured to screen said requests.

90. The system of claim 77 wherein the central facility is configured to send said outgoing electronic mail.

91. The system of claim 90 wherein the central facility is configured to send a follow-up electronic mail to said one of the electronic mail addresses.

92. The system of claim 77 wherein the central facility is configured to send a fee-required electronic mail that includes a link for paying a fee to receive said outgoing electronic mail.

93. The system of claim 77 wherein the central facility is configured to include an order form in said outgoing electronic mail.

94. The system of claim 77 further comprising user equipment of an information requestor that is configured to display an electronic banner that can be selected to automatically create said incoming electronic mail.

95. The system of claim 77 further comprising user equipment of information requestor that is configured to display an electronic link that can be selected to automatically create said incoming electronic mail.

96. The system of claim 77 wherein the central facility is configured to provide to an information requestor that sent said incoming electronic mail, a selectable option for downloading a software program that displays a selectable icon that automatically populates a portion of an electronic mail address field.

97. The system of claim 77 wherein the central facility is configured to provide to an information requestor that sent said incoming electronic mail, a selectable option for referring future ones of said outgoing electronic mail to other electronic mail addresses.

98. The system of claim 77 wherein the central facility is configured to provide to an information requestor that sent said incoming electronic mail, a selectable option to store personal information at the central facility.

99. The system of claim 77 wherein the central facility is configured to provide to an information requestor that sent said incoming electronic mail from their user equipment, a selectable option for creating a folder for storing said outgoing electronic mail on said user equipment.

100. The system of claim 77 wherein the central facility is configured to log an information requestor that sent said incoming electronic mail into the central facility to review said outgoing electronic mail.

101. The system of claim 77 wherein the central facility is configured to provide to an information requestor that sent said incoming electronic mail, a selectable option to receive access to past ones of said outgoing electronic mail.

102. The system of claim 77 wherein the central facility is configured to determine whether user equipment from which said incoming electronic mail was sent is capable of displaying graphics in said outgoing electronic mail.

103. The system of claim 77 wherein the central facility is configured to include graphics in said outgoing electronic mail.

104. The system of claim 77 wherein the central facility is configured to attach a file to said outgoing electronic mail.

105. The system of claim 77 wherein the central facility is configured to receive the promotional information for one of said information disseminators for storing the promotional information in said database.

106. The system of claim 77 wherein the central facility is configured to give the information disseminators access to said database.

107. The system of claim 77 wherein the central facility is configured to:
generate cumulative tracking information for said one of said registered electronic mail addresses; and
form a communications connection with one of said information disseminators to access the cumulative tracking information.

108. The system of claim 77 wherein the central facility is configured to:
generate tracking information for said incoming electronic mail; and
form a communications connection with one of said information disseminators to access the cumulative tracking information.

109. The system of claim 77 wherein the central facility is configured to configure said outgoing electronic mail to return information on actions taken when said outgoing electronic mail is received.

110. The system of claim 77 wherein the central facility is configured to receive said incoming electronic mail that includes a security code.

111. The system of claim 77 wherein the central facility is configured to receive in the promotional information for one of said information disseminators an electronic mail template.

112. The system of claim ill wherein the central facility is configured to use said electronic mail template to create said outgoing electronic mail.

113. The system of claim 112 wherein the central facility is configured to insert an individual tracking code in portions of said electronic mail template to create said outgoing electronic mail.

114. The system of claim 112 wherein the central facility is configured to insert in said electronic mail template an individual tracking code to replace instances of symbol “˜” in said electronic mail template.

115. A method comprising:
registering electronic mail addresses each of which has (1) a fixed portion, which serves as a global identifier for a central information dissemination service, and (2) a code portion, said code portion of each electronic mail address being associated with particular subject matter and associated with information related to that particular subject matter that one of a plurality of information disseminators is to disseminate;
publishing one of said code portions in connection with said particular subject matter with which that code portion is associated; and
disseminating, by said information disseminator service on behalf of said one of said plurality of information disseminators, said information associated with said published one of said code portions.

116. The method of claim 115 further comprising receiving an incoming electronic mail at the central information disseminator service, said incoming electronic mail being addressed to one of said registered electronic mail addresses.

117. The method of claim 116 wherein the disseminating comprises creating in response to the incoming electronic mail, an outgoing electronic mail that is based on the information associated with said one of said registered electronic mail addresses.

118. The method of claim 116 further comprising tracking individual tracking information related to said incoming electronic mail.

119. The method of claim 115 wherein the disseminating comprises disseminating said information using electronic mail.

120. The method of claim 115 wherein the registering comprises registering said electronic mail addresses that each have a same second-level domain name for said fixed portion.

121. The method of claim 115 further comprising receiving a request from one said information disseminators to register a particular code in registering one of said electronic mail addresses.

122. The method of claim 115 further comprising associating the information related to one of said particular subject matter with more than one of said registered electronic mail addresses.

123. The method of claim 115 further comprising tracking each of said electronic mail addresses.

124. A system comprising:
means for registering electronic mail addresses each of which has (1) a fixed portion, which serves as a global identifier for a central information dissemination service, and (2) a code portion, said code portion of each electronic mail address being associated with particular subject matter and associated with information related to that particular subject matter that one of a plurality of information disseminators is to disseminate;
means for publishing one of said code portions in connection with said particular subject matter with which that code portion is associated; and
means for disseminating, by said information disseminator service on behalf of said one of said plurality of information disseminators, said information associated with said published one of said code portions.

125. The system of claim 124 further comprising means for receiving an incoming electronic mail at the central information disseminator service, said incoming electronic mail being addressed to one of said registered electronic mail addresses.

126. The system of claim 125 wherein the means for disseminating comprises means for creating in response to the incoming electronic mail, an outgoing electronic mail that is based on the information associated with said one of said registered electronic mail addresses.

127. The system of claim 124 further comprising means for tracking individual tracking information related to said incoming electronic mail.

128. The system of claim 124 wherein the means for disseminating comprises means for disseminating said information using electronic mail.

129. The system of claim 124 wherein the means for registering comprises means for registering said electronic mail addresses that each have a same second-level domain name for said fixed portion.

130. The system of claim 124 further comprising means for receiving a request from one said information disseminators to register a particular code in registering one of said electronic mail addresses.

131. The system of claim 124 further comprising means for associating the information related to one of said particular subject matter with more than one of said registered electronic mail addresses.

132. The system of claim 124 further comprising means for tracking each of said electronic mail addresses.

133. A system comprising:
a central facility at which a software application has been implemented to configure the central facility to register electronic mail addresses each of which has (1) a fixed portion, which serves as a global identifier for a central information dissemination service, and (2) a code portion, said code portion of each electronic mail address being associated with particular subject matter and associated with information related to that particular subject matter that one of a plurality of information disseminators is to disseminate;
media for publishing one of said code portions in connection with said particular subject matter with which that code portion is associated; and
the central facility being further configured to disseminate on behalf of said one of said plurality of information disseminators, said information associated with said published one of said code portions.

134. The system of claim 133 wherein the central facility is configured to receive an incoming electronic mail, said incoming electronic mail being addressed to one of said registered electronic mail addresses.

135. The system of claim 134 wherein the central facility is configured to create in response to the incoming electronic mail, an outgoing electronic mail that is based on the information associated with said one of said registered electronic mail addresses.

136. The method of claim 134 wherein the central facility is configured to track individual tracking information related to said incoming electronic mail.

137. The system of claim 133 wherein the central facility is configured to disseminate said information using electronic mail.

138. The system of claim 133 wherein the central facility is configured to register said electronic mail addresses that each have a same second-level domain name for said fixed portion.

139. The system of claim 133 wherein the central facility is configured to receive a request from one said information disseminators to register a particular code in registering one of said electronic mail addresses.

140. The system of claim 133 wherein the central facility is configured to associate the information related to one of said particular subject matter with more than one of said registered electronic mail addresses.

141. The system of claim 133 wherein the central facility is configured to track each of said electronic mail addresses.

142. A machine-readable storage medium encoded with a set of machine executable instructions for using a central facility to perform a method for providing a central information dissemination service that makes information available to the public, comprising:
registering electronic mail addresses at a central facility for different information disseminators that distribute promotional information;
storing, in a database at the central facility, the promotional information for each information disseminator in association with the electronic mail address of that information disseminator;
receiving an incoming electronic mail at the central facility, said incoming electronic mail addressed to one of the registered electronic mail addresses; and
creating in response to the incoming electronic mail, an outgoing electronic mail that is based on the promotional information associated with the registered electronic mail address of said incoming electronic mail.

143. The machine-readable storage medium of claim 142 wherein said method further comprises tracking activity of the registered electronic mail addresses.

144. The machine-readable storage medium of claim 142 wherein said method further comprises assigning a global tracking code to each registered electronic mail address

145. The machine-readable storage medium of claim 142 wherein said method further comprises assigning an individual tracking code to the incoming electronic mail.

146. The machine-readable storage medium of claim 142 wherein the registering comprises registering different electronic mail addresses for one of said information disseminators that are each to be used for different advertisements having the same focus.

147. The machine-readable storage medium of claim 142 wherein said method further comprises assigning a tracking code to each of said different electronic mail addresses that are to be used for said different advertisements having the same focus to track activity of said different electronic mail addresses across the different advertisements.

148. The machine-readable storage medium of claim 142 wherein said method further comprises assigning a tracking code to each of said different electronic mail addresses that are to be used for said different advertisements having the same focus to track activity of said different electronic mail addresses across the different media.

149. The machine-readable storage medium of claim 142 wherein said method further comprises generating a report based on receiving said incoming electronic mail.

150. The machine-readable storage medium of claim 142 wherein said method further comprises generating a report based on how many of said incoming electronic mails have been received that are addressed to said one of the registered electronic mail addresses.

151. The machine-readable storage medium of claim 142 wherein said method further comprises receiving requests to register said electronic mail addresses.

152. The machine-readable storage medium of claim 151 wherein said method further comprises screening said requests.

153. The machine-readable storage medium of claim 142 wherein said method further comprises sending said outgoing electronic mail.

154. The machine-readable storage medium of claim 153 wherein said method further comprises sending a follow-up electronic mail to said one of the electronic mail addresses.

155. The machine-readable storage medium of claim 142 wherein said method further comprises sending a fee required electronic mail that includes a link for paying a fee to receive said outgoing electronic mail.

156. The machine-readable storage medium of claim 142 wherein the creating comprises including an order form in said outgoing electronic mail.

157. The machine-readable storage medium of claim 142 wherein said method further comprises displaying an electronic banner that can be selected to automatically create said incoming electronic mail.

158. The machine-readable storage medium of claim 142 wherein said method further comprises displaying an electronic link that can be selected to automatically create said incoming electronic mail.

159. The machine-readable storage medium of claim 142 wherein said method further comprises providing to an information requestor that sent said incoming electronic mail, a selectable option for downloading a software program that displays a selectable icon that automatically populates a portion of an electronic mail address field.

160. The machine-readable storage medium of claim 142 wherein said method further comprises providing to an information requestor that sent said incoming electronic mail, a selectable option for referring future ones of said outgoing electronic mail to other electronic mail addresses.

161. The machine-readable storage medium of claim 142 wherein said method further comprises providing to an information requestor that sent said incoming electronic mail, a selectable option to store personal information at the central facility.

162. The machine-readable storage medium of claim 142 wherein said method further comprises providing to an information requestor that sent said incoming electronic mail from their user equipment, a selectable option for creating a folder for storing said outgoing electronic mail on said user equipment.

163. The machine-readable storage medium of claim 142 wherein said method further comprises logging an information requestor that sent said incoming electronic mail into the central facility to review said outgoing electronic mail.

164. The machine-readable storage medium of claim 142 wherein said method further comprises providing to an information requestor that sent said incoming electronic mail, a selectable option to receive access to past ones of said outgoing electronic mail.

165. The machine-readable storage medium of claim 142 wherein said method further comprises determining whether user equipment from which said incoming electronic mail was sent is capable of displaying graphics in said outgoing electronic mail.

166. The machine-readable storage medium of claim 142 wherein the creating comprises including graphics in said outgoing electronic mail.

167. The machine-readable storage medium of claim 142 wherein said method further comprises attaching a file to said outgoing electronic mail.

168. The machine-readable storage medium of claim 142 wherein said method further comprises receiving the promotional information for one of said information disseminators for storing the promotional information in said database.

169. The machine-readable storage medium of claim 142 wherein said method further comprises giving the information disseminators access to said database.

170. The machine-readable storage medium of claim 142 wherein said method further comprises:
generating cumulative tracking information for said one of said registered electronic mail addresses; and
forming a communications connection with one of said information disseminators to access the cumulative tracking information.

171. The machine-readable storage medium of claim 142 wherein said method further comprises:
generating tracking information for said incoming electronic mail; and
forming a communications connection with one of said information disseminators to access the cumulative tracking information.

172. The machine-readable storage medium of claim 142 wherein the creating comprises configuring said outgoing electronic mail to return information on actions taken when said outgoing electronic mail is received.

173. The machine-readable storage medium of claim 142 wherein the receiving comprises receiving said incoming electronic mail that includes a security code.

174. The machine-readable storage medium of claim 142 wherein the storing comprises providing in the promotional information for one of said information disseminators an electronic mail template.

175. The machine-readable storage medium of claim 174 wherein the creating comprises using said electronic mail template to create said outgoing electronic mail.

176. The machine-readable storage medium of claim 175 wherein the creating comprises inserting an individual tracking code in portions of said electronic mail template to create said outgoing electronic mail.

177. The machine-readable storage medium of claim 175 wherein the creating comprises inserting in said electronic mail template an individual tracking code to replace instances of symbol “in said electronic mail template.
